(19) United States
(12) Patent Application Publication
(10) Pub. No.: US 2015/0155144 A1
(43) Pub. Date: Jun. 4, 2015

(54) GEIGER-MULLER COUNTER TUBE AND RADIATION MEASUREMENT APPARATUS

(71) Applicant: NIHON DEMPA KOGYO CO., LTD., Tokyo (JP)

(72) Inventors: TOSHIAKI TAKEUCHI, SAITAMA (JP); KUNIO HAMAGUCHI, SAITAMA (JP); KUICHI KUBO, SAITAMA (JP); KOZO ONO, SAITAMA (JP); NORITOSHI KIMURA, SAITAMA (JP)

(21) Appl. No.: 14/558,729

(22) Filed: Dec. 3, 2014

(30) Foreign Application Priority Data
Dec. 4, 2013 (JP) 2013-251432
Dec. 17, 2013 (JP) 2013-259691
Mar. 20, 2014 (JP) 2014-058613
Jun. 6, 2014 (JP) 2014-117158

(51) Int. Cl. H01J 47/08; G01T 1/18

(52) U.S. Cl. CPC H01J 47/08; G01T 1/18

(57) ABSTRACT

A Geiger-Muller counter tube includes a cylindrical enclosing tube, an anode electrode, a cylindrical cathode electrode, a bead, an inert gas, and a quenching gas. The cylindrical enclosing tube has a sealed space. The anode electrode is disposed inside the space and formed in a rod shape. The cylindrical cathode electrode surrounds a peripheral area of the anode electrode inside the space. The bead is formed of an insulator and having a through-hole in the center, the anode electrode passing through the through-hole. The bead is secured to the anode electrode in a position where the anode electrode is surrounded by the cathode electrode. The inert gas and the quenching gas are sealed inside the space. The bead prevents a direct contact between the anode electrode and the cathode electrode.

### CROSS-REFERENCE TO RELATED APPLICATIONS

This application claims the priority benefit of Japanese application serial no. 2013-251432, filed on Dec. 4, 2013, no. 2013-259691, filed on Dec. 17, 2013, no. 2014-058613, filed on Mar. 20, 2014, and no. 2014-117158, filed on Jun. 6, 2014. The entirety of each of the above-mentioned patent applications is hereby incorporated by reference herein and made a part of specification.

### TECHNICAL FIELD

This disclosure relates to a Geiger-Muller counter tube and a radiation measurement apparatus that includes a bead or a ring.

### DESCRIPTION OF THE RELATED ART

A Geiger-Muller counter tube (GM counter tube) is a component that is mainly used in a radiation measurement apparatus. The GM counter tube includes electrodes formed as an anode and a cathode. In the GM counter tube, inert gas is enclosed. Additionally, between the anode electrode and the cathode electrode of the GM counter tube, a high voltage is applied in use. The radiation that enters into the inside of the GM counter tube ionizes the inert gas into an electron and an ion. The ionized electron and ion are accelerated toward the respective anode electrode and cathode electrode. This causes electrical conduction between the anode electrode and the cathode electrode so as to generate a pulse signal. For example, Japanese Unexamined Patent Application Publication No. 62-149158 (hereinafter referred to as Patent Literature 1) discloses a radiation detection tube where a pair of electrodes is formed.

However, in Patent Literature 1, for example, the relative position between the electrodes is different for each product. This causes a variation of the characteristics of the radiation detection tube, and further there is a possibility of short circuit when the electrodes come in contact with each other.

A need thus exists for a GM counter tube and a radiation measurement apparatus which are not susceptible to the drawback mentioned above.

### SUMMARY

A Geiger-Muller counter tube according to a first aspect of the disclosure includes a cylindrical enclosing tube, an anode electrode, a cathode electrode in a cylindrical shape, a bead, an inert gas, and a quenching gas. The cylindrical enclosing tube has a space which is sealed. The anode electrode is disposed inside the space and formed in a rod shape. The cathode electrode surrounds a peripheral area of the anode electrode inside the space. The bead is formed of an insulator and a through-hole is in a center of the bead. The anode electrode passes through the through-hole. The bead is secured to the anode electrode in a position where the anode electrode is surrounded by the cathode electrode. The inert gas and the quenching gas are sealed inside the space. A direct contact between the anode electrode and the cathode electrode is prevented by using the bead.

### BRIEF DESCRIPTION OF THE DRAWINGS

The foregoing and additional features and characteristics of this disclosure will become more apparent from the following detailed description considered with reference to the accompanying drawings.

FIG. 1A is a sectional drawing of a Geiger-Muller counter tube 10.

FIG. 1B is a plan view of a bead 850.

FIG. 1C is a cross-sectional view taken along the line IC-IC of FIG. 1A.

FIG. 2 is a schematic configuration diagram of a radiation measurement apparatus 20.

FIG. 3A is a sectional drawing of a Geiger-Muller counter tube 30.

FIG. 3B is a schematic perspective view of a bead 853.

FIG. 4A is a schematic perspective view of a Geiger-Muller counter tube 40.

FIG. 4B is a plan view of a bead 856.

FIG. 5A is a schematic sectional drawing of a Geiger-Muller counter tube 50.

FIG. 5B is a side view of the Geiger-Muller counter tube 50 viewed from the +Z-axis side to the −Z-axis direction.

FIG. 6A is a sectional drawing of a Geiger-Muller counter tube 110.

FIG. 6B is a schematic side view of the Geiger-Muller counter tube 110 mounted on a substrate.

FIG. 7 is a schematic configuration diagram of a radiation measurement apparatus 100.

FIG. 8A is a schematic configuration diagram of a Geiger-Muller counter tube 210.

FIG. 8B is a schematic configuration diagram of a radiation measurement apparatus 200.

FIG. 9A is a sectional drawing of a Geiger-Muller counter tube 310.

FIG. 9B is a schematic sectional drawing of a Geiger-Muller counter tube 310a.

FIG. 10A is a sectional drawing of a Geiger-Muller counter tube 410.

FIG. 10B is a schematic sectional drawing of a Geiger-Muller counter tube 410a.

FIG. 11 is a schematic configuration diagram of a radiation measurement apparatus 500.

FIG. 12 is a graph that compares the number of discharges of radiation measurement apparatuses.

FIG. 13 is a schematic configuration diagram of a radiation measurement apparatus 600.

FIG. 14 is a schematic configuration diagram of a radiation measurement apparatus 700.

FIG. 15A is a schematic perspective view of an anode electrode 12a, the bead 850, and a cathode electrode 63a that constitute a Geiger-Muller counter tube 60.

FIG. 15B is a cross-sectional view taken along the line XVB-XVB of FIG. 15A.

### DETAILED DESCRIPTION

The embodiments of this disclosure will be described in detail below with reference to the attached drawings. It will be understood that the scope of the disclosure is not limited to the described embodiments, unless otherwise stated.

### [Configuration of Geiger-Muller Counter Tube 10 of First Embodiment]

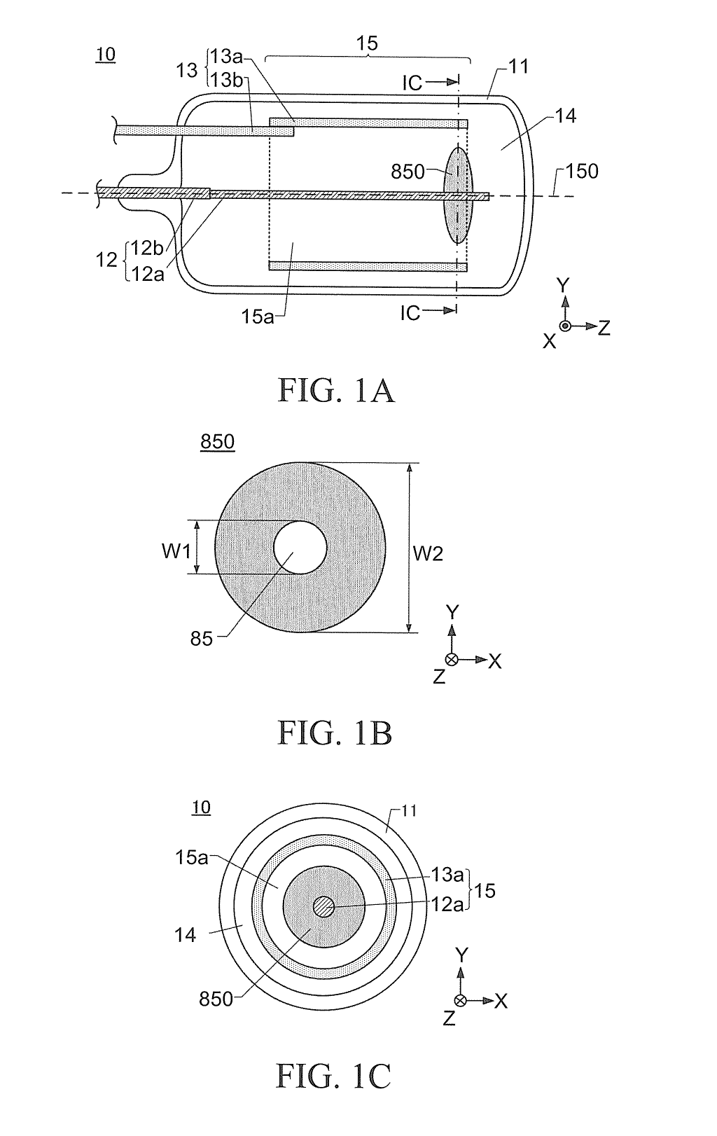

FIG. 1A is a sectional drawing of the Geiger-Muller counter tube 10. The Geiger-Muller counter tube 10 is constituted of an enclosing tube 11, an anode conductor 12, and a cathode conductor 13. In the following description, assume that the extending direction of the enclosing tube 11 is the Z-axis direction, the diametrical direction of the enclosing tube 11 which is perpendicular to the Z-axis direction is the X-axis direction. Similarly, assume that the diametrical direction of the enclosing tube 11 which is perpendicular to the X-axis direction and the Z-axis direction is the Y-axis direction.

The enclosing tube 11 is, for example, formed of glass in a cylindrical shape. Both ends of the +Z-axis side and the −Z-axis side of the enclosing tube 11 is sealed and a space 14 inside the enclosing tube 11 is sealed. The anode conductor 12 and the cathode conductor 13 pass through the end of the −Z-axis side of the enclosing tube 11.

The anode conductor 12 is constituted of an anode electrode 12a and a linear first metal lead portion 12b. The anode electrode 12a which is rod-shaped is disposed in the space 14. The first metal lead portion 12b is connected to the anode electrode 12a and supported at the end of the enclosing tube 11. The first metal lead portion 12b is supported at the end of the −Z-axis side of the enclosing tube 11. The end of the −Z-axis side of the anode electrode 12a is connected to the first metal lead portion 12b. Further, in the Geiger-Muller counter tube 10, the anode electrode 12a is disposed on one straight line 150 extending in the Z-axis direction.

The cathode conductor 13 includes a cylindrical cathode electrode 13a and a linear second metal lead portion 13b. The cathode electrode 13a surrounds the peripheral area of the anode electrode 12a in the space 14. The second metal lead portion 13b is connected to the cathode electrode 13a and is supported at the end of the enclosing tube 11. The second metal lead portion 13b is supported at the end of the −Z-axis side of the enclosing tube 11. The end of the −Z-axis side of the cathode electrode 13a is connected to the second metal lead portion 13b.

A radiation detecting unit 15 which detects the radiation is constituted of the anode electrode 12a and the cathode electrode 13a which surrounds the anode electrode 12a. The radiation detecting unit 15 has a space 15a which is the space to detect the radiation. The space 15a is the space which is surrounded by the cathode electrode 13a and is the region which includes both of the anode electrode 12a and the cathode electrode 13a inside an XY plane inside the space. Additionally, the anode electrode 12a is inserted from an opening of the −Z-axis side of the cathode electrode 13a. Then, the anode electrode 12a is disposed to pass through the space 15a and protrude from the opening of the +Z-axis side of the cathode electrode 13a. Because the anode electrode 12a is disposed to protrude from the opening of the +Z-axis side of the cathode electrode 13a, a position of a tip of the anode electrode 12a can be confirmed. Therefore, it can be confirmed whether or not the anode electrode 12a largely deviates from the central axis of the cathode electrode 13a. Furthermore, a bead 850 is mounted to the anode electrode 12a which is inside the space 15a and is near the opening of the +Z-axis side of the cathode electrode 13a.

FIG. 1B is a plan view of the bead 850. The outer shape of the bead 850 is, for example, a rotational ellipsoid (doughnut shape), i.e., it is a rotator which is obtained with a short axis of an ellipse as a revolving shaft. There is fanned a through-hole 851 which passes through the bead 850 along the revolving shaft. The anode electrode 12a is passed through the through-hole 851 of the bead 850, and the bead 850 is secured to the anode electrode 12a. Accordingly, assuming that W1 is a diameter of the through-hole 851 of the bead 850, the diameter W1 is formed so as to be equal to or more than a wire diameter of the anode electrode 12a. In addition, the bead 850 is disposed so as to be surrounded by the cathode electrode 13a inside an XY plane. Thus, assuming that W2 is an outside diameter of the bead 850 inside the XY plane, the outside diameter W2 is formed so as to be smaller than an inside diameter of the cathode electrode 13a.

Securing of the bead 850 to the anode electrode 12a can be performed, for example, by filling low melting point glass or similar material into the gap between the anode electrode 12a and the through-hole 851 so as to close the gap. Furthermore, with the difference between the diameter W1 of the bead 850 and the wire diameter of the anode electrode 12a decreased, the securing of the bead 850 to the anode electrode 12a may be performed by increasing the friction force between the bead 850 and the anode electrode 12a.

The bead 850 is formed of an insulator to keep electrical insulation between the anode electrode 12a and the cathode electrode 13a. Furthermore, an inert gas and a quenching gas are enclosed inside the enclosing tube 11. However, when other gas is additionally mixed inside the enclosing tube 11, the characteristics of the Geiger-Muller counter tube is affected. Therefore, the material of the bead 850 is preferred not to be a source of generation of gas. So as to fulfill these described above, the bead 850 is formed of, for example, hard glass, molybdenum glass, ceramic, plastic or similar material.

FIG. 1C is a cross-sectional view taken along the line IC-IC of FIG. 1A. The anode electrode 12a is disposed on the central axis of the cathode electrode 13a. That is, the central axis of the cathode electrode 13a is disposed on the straight line 150 (see FIG. 1A). Accordingly, when a voltage is applied between the cathode electrode 13a and the anode electrode 12a, inside the XY plane, the electric field of the space 15a surrounded by the cathode electrode 13a is formed with rotational symmetry around the anode electrode 12a. In addition, in the space 14 which has the space 15a, the inert gas and the quenching gas are enclosed. The inert gas employs, for example, noble gas such as helium (He), neon (Ne), or argon (Ar). Additionally, the quenching gas employs, for example, halogen-based gas such as fluorine (F), bromine (Br) or chlorine (Cl).

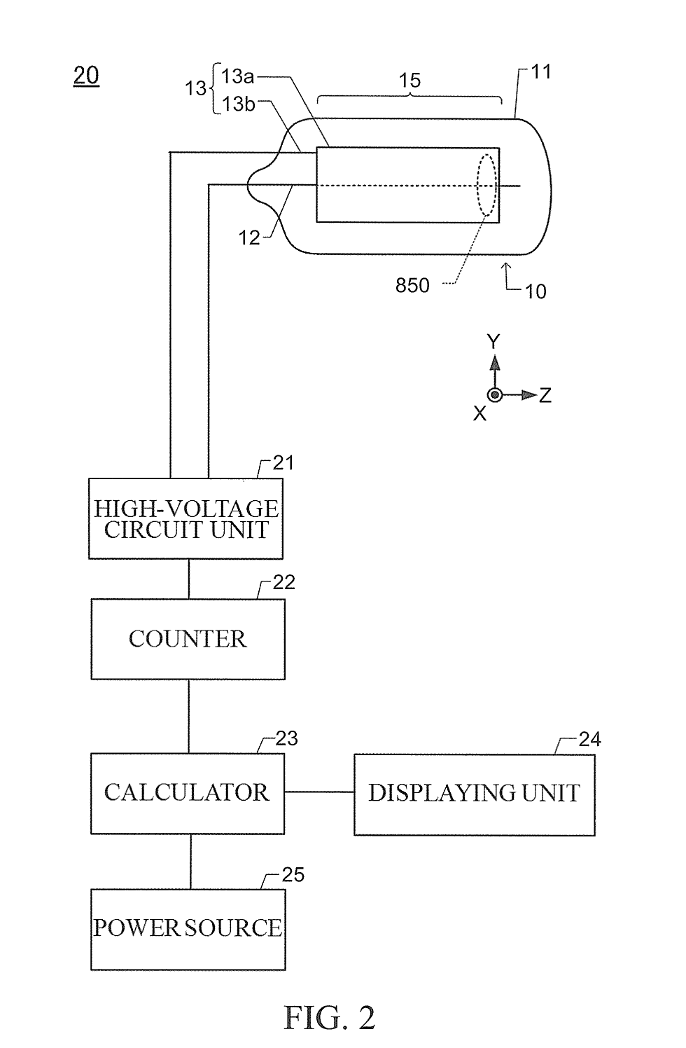

In the Geiger-Muller counter tube 10, when the radiation enters into the space 15a via the enclosing tube 11, the radiation ionizes the inert gas into a positively charged ion and a negatively charged electron. Further, applying a voltage, for example, from 400V to 600V between the anode electrode 12a and the cathode electrode 13a forms an electric field in the space 15a. Accordingly, the ionized ion and electron are accelerated toward the respective cathode electrode 13a and anode electrode 12a. The accelerated ions collide with another inert gas so as to ionize the other inert gas. This repetition of ionizations forms ionized ions and electrons like an avalanche in the space 15a, thus causing a flow of a pulse current. A radiation measurement apparatus 20 (see FIG. 2) with the Geiger-Muller counter tube 10 can measure the number of pulses of a pulse signal due to this pulse current so as to measure the radiation dose. Additionally, when this current continuously flows, the number of pulses cannot be measured. In order to prevent this situation, the quenching gas is enclosed in the space 14 together with the inert gas. The quenching gas has an action for dispersing the energy of the ion.

In such Geiger-Muller counter tube, the anode electrode is preferred to be disposed on the central axis of the cathode electrode. This is because there is possibility of short circuit between the anode electrode and the cathode electrode, when the anode electrode deviates from the central axis of the cathode electrode. Furthermore, even if there is no short circuit between the anode electrode and the cathode electrode, deviation of the anode electrode from the central axis of the cathode electrode becomes the cause of the variation of the characteristics of the Geiger-Muller counter tube in some cases. In particular, when the difference between the inside diameter of the cathode electrode and the outside diameter of the anode electrode becomes larger, the variation becomes larger. However, in the manufacturing process, it is not easy to stably arrange the anode electrode on the central axis of the cathode electrode. Therefore, the short circuit between the electrodes and the variation of the characteristics of the Geiger-Muller counter tube are not completely suppressed.

In the Geiger-Muller counter tube 10, as illustrated in FIG. 1C, the bead 850 is mounted to the anode electrode 12a, and the bead 850 keeps the gap between the anode electrode 12a and the cathode electrode 13a in a predetermined range. Thus, arranging the anode electrode 12a near the central axis of the cathode electrode 13a becomes easier. Accordingly, production of the Geiger-Muller counter tube is facilitated. Furthermore, the short circuit between the cathode electrode and the anode electrode is prevented, and the variation of the characteristics of the Geiger-Muller counter tube can be suppressed.

In the Geiger-Muller counter tube 10, the bead 850 is formed in the shape close to the rotational ellipsoid. The outer shape of the bead 850 can be formed in various shapes such as a cylindrical shape, a discoidal shape, an ellipsoidal shape, a spherical shape, or an annular ring shape (torus body). Furthermore, the forming position of the bead 850 is not limited to the tip side the anode electrode 12a inside the space 15a, and the bead 850 may be formed at any position inside the space 15a. The number of formations of the bead 850 is not limited to one, and a plurality of the beads 850 may be disposed inside the space 15a.

### [Configuration of Radiation Measurement Apparatus 20]

FIG. 2 is a schematic configuration diagram of the radiation measurement apparatus 20. The Geiger-Muller counter tube 10 is, for example, can be employed for the radiation measurement apparatus 20. The radiation measurement apparatus 20 is constituted including the Geiger-Muller counter tube 10, and the anode conductor 12 and the cathode conductor 13 are connected to a high-voltage circuit unit 21. In the radiation measurement apparatus 20, the radiation is measured by the application of the high voltage between the anode conductor 12 and cathode conductor 13. The high-voltage circuit unit 21 is connected to a counter 22. The pulse signal detected by the radiation detecting unit 15 of the Geiger-Muller counter tube 10 is counted by the counter 22, and then converted into the radiation dose by a calculator 23. The converted radiation dose is displayed on a displaying unit 24. The calculator 23 connects to a power source 25 to receive the electric power.

### Second Embodiment

In the Geiger-Muller counter tube, the bead can be formed in various shapes by various methods. Further, instead of an arrangement of the bead to the anode electrode, a ring may be formed to the cathode electrode. The following description describes modifications of such Geiger-Muller counter tube 10. Like reference numerals designate corresponding or identical elements throughout the Geiger-Muller counter tube 10, and therefore such elements will not be further elaborated here.

### [Configuration of Geiger-Muller Counter Tube 30]

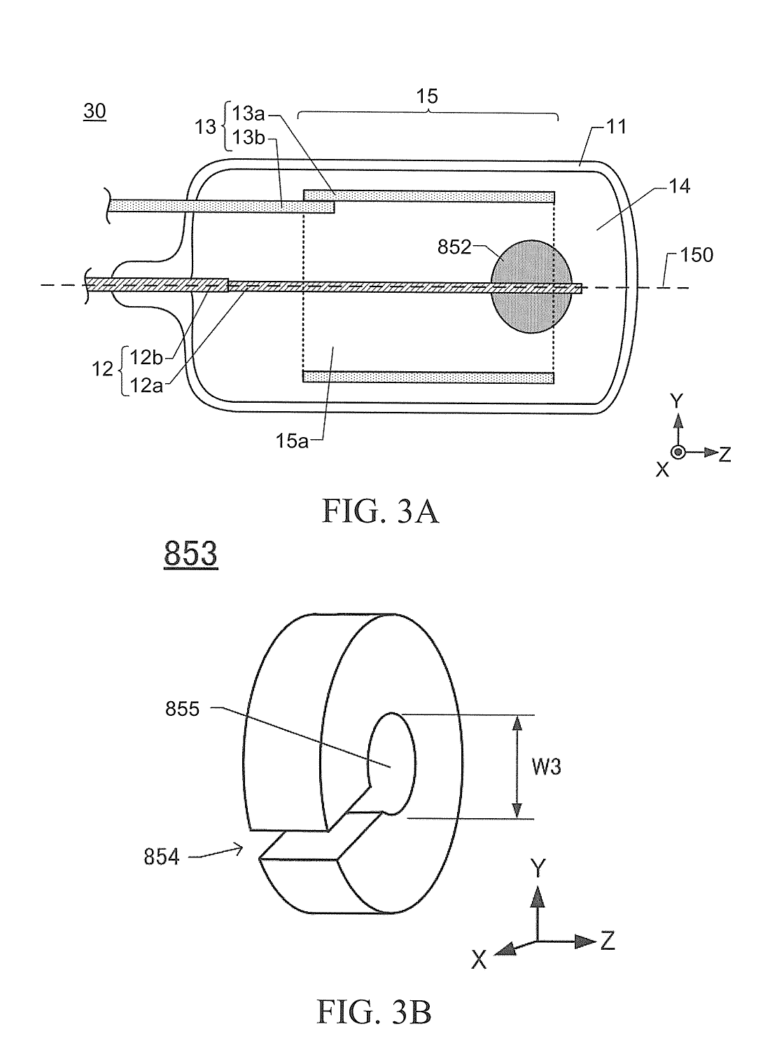

FIG. 3A is a sectional drawing of a Geiger-Muller counter tube 30. The Geiger-Muller counter tube 30 is constituted including the enclosing tube 11, the anode conductor 12, the cathode conductor 13, and a bead 852 which is mounted to the anode electrode 12a. The Geiger-Muller counter tube 30 is one where, in the Geiger-Muller counter tube 10, the bead 850 is replaced to the bead 852. Similar to the bead 850, the bead 852 is formed near the opening of the +Z-axis side of the cathode electrode 13a.

In the bead 850 of the Geiger-Muller counter tube 10, the bead which preliminarily has the through-hole 851 is formed and then mounted to the anode electrode 12a. However, the bead may be directly formed to the anode electrode 12a. The bead 852 is fawned in the following method, i.e., molten low melting point glass is directly applied over the anode electrode 12a, and then is solidified in a near spherical shape.

### [Configuration of Bead 853]

FIG. 3B is a schematic perspective view of the bead 853. In the Geiger-Muller counter tube 10, the bead 853 where a slit 854 is formed may be employed instead of the bead 850. The outer shape of the bead 853 is formed in a discoidal shape, and a through-hole 855 at the center of the bead 853 and the outer periphery of the bead 853 are connected by the slit 854. In addition, in the bead 853, a diameter W3 of the through-hole 855 is foamed to be smaller than the outside diameter of the anode electrode 12a. In the bead 853, the slit 854 being widened temporarily, the diameter W3 can be widened larger than the outside diameter of the anode electrode 12a. Therefore, mounting of the bead 853 to the anode electrode 12a becomes easier. Further, the diameter W3 is ordinarily smaller than the outside diameter of the anode electrode 12a. Accordingly, when the bead 853 is mounted to the anode electrode 12a, the bead 853 can strongly hold the anode electrode 12a, which is preferred.

### [Configuration of Geiger-Muller Counter Tube 40]

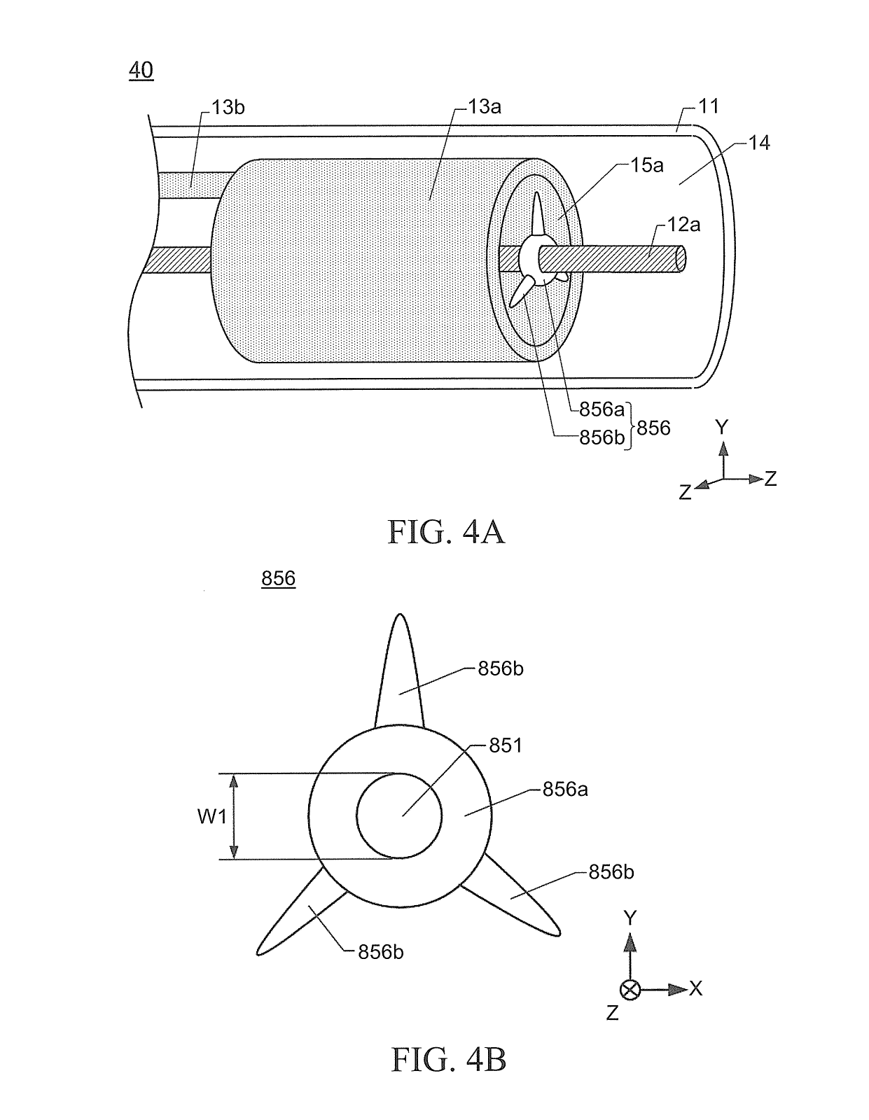

FIG. 4A is a schematic perspective view of a Geiger-Muller counter tube 40. The Geiger-Muller counter tube 40 is constituted including the enclosing tube 11, the anode conductor 12, the cathode conductor 13, and a bead 856 which is mounted to the anode electrode 12a. The Geiger-Muller counter tube 40 is one where, in the Geiger-Muller counter tube 10, the bead 850 is replaced to the bead 856. Similar to the bead 850, the bead 856 is disposed at the tip side of the anode electrode 12a inside the space 15a.

FIG. 4B is a plan view of the bead 856. The bead 856 is formed of a body 856a and three protrusions 856b. The body 856a is mounted to the anode electrode 12a and three protrusions 856b are mounted to the body 856a. Further, each protrusion 856b is disposed, for example, on the outer periphery of the body 856a at regular intervals. In the Geiger-Muller counter tube 40, the gap between the anode electrode 12a and cathode electrode 13a is kept within a range of a predetermined distance, where the variation of the characteristics of the Geiger-Muller counter tube 40 is suppressed within an allowable range.

In the bead 850 (see FIG. 1B), the anode electrode 12a is disposed near the central axis of the cathode electrode 13a. Thus, when the outside diameter W2 becomes larger, there is a concern that the bead 850 close the opening of the cathode electrode 13a and a flow of the gas inside and outside of the space 15a becomes poor. Accordingly, there is a concern that the characteristics of the Geiger-Muller counter tube are affected due to generation of a concentration difference of the gas inside and outside of the space 15a. In the case of using the bead 856, the anode electrode 12a is disposed near the central axis of the cathode electrode 13a by the protrusion 856b, and at the same time the bead 856 does not close the opening of the cathode electrode 13a. Accordingly, generation of the concentration difference of the gas inside and outside of the space 15a is prevented, and influence to the characteristics of the Geiger-Muller counter tube is prevented.

### [Configuration of Geiger-Muller Counter Tube 50]

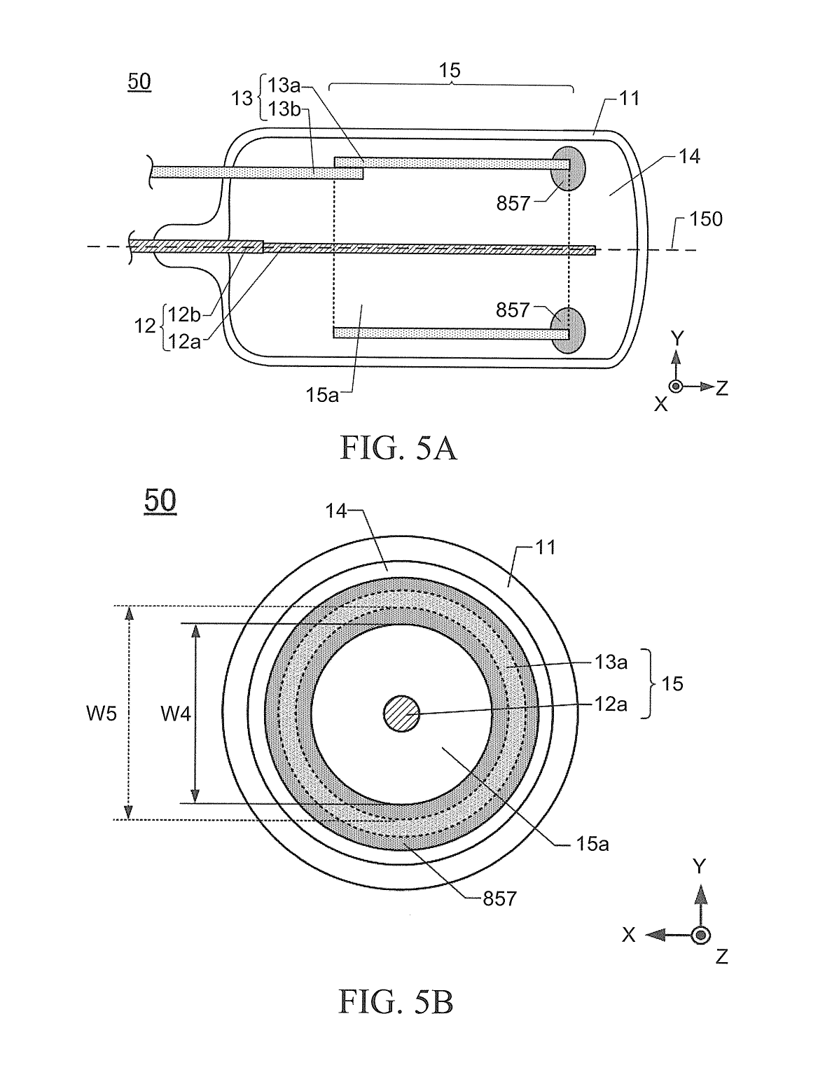

FIG. 5A is a schematic sectional drawing of a Geiger-Muller counter tube 50. The Geiger-Muller counter tube 50 is constituted including the enclosing tube 11, the anode conductor 12, the cathode conductor 13, and a ring 857 that is mounted to the cathode electrode 13a. The ring 857 is disposed so as to cover the edge of the opening of the +Z-axis side, which is the opening of the cathode electrode 13a in the side where the anode electrode 12a passes through from the space 15a.

The ring 857 can be formed, for example, by the application of low melting point glass over the peripheral area of the cathode electrode 13a and then by the cooling of the glass. Additionally, the ring 857 can be formed as follows, i.e., a ring formed of the insulator such as hard glass, molybdenum glass, ceramic, or plastic is engaged into the opening of the cathode electrode 13a, or the ring is fixed in the opening of the cathode electrode 13a with the use of an adhesive material such as low melting point glass.

FIG. 5B is a side view of the Geiger-Muller counter tube 50 viewed from the +Z-axis side to the −Z-axis direction. The ring 857 is formed in the peripheral area of the cathode electrode 13a. Further, assuming that the inside diameter of the cathode electrode 13a is W5 and that of the ring 857 is W4, the inside diameter W4 of the ring 857 is formed to be smaller than the inside diameter W5 of the cathode electrode 13a. This ensures the prevention of short circuit due to contact between the cathode electrode 13a and the anode electrode 12a, even when the anode electrode 12a deviates from the central axis of the cathode electrode 13a.

In addition, in the Geiger-Muller counter tube 50, by decreasing the size of the inside diameter W4, the position of the anode electrode 12a can be limited to the position near the central axis of the cathode electrode 13a. Furthermore, when the bead is mounted to the anode electrode, there is a concern that the anode electrode deforms due to the weight of the bead. However, because the diameter of the cathode electrode is larger than the anode electrode, and the cathode electrode is hardly deformed, there is no need to worry about the deformation or a similar defect of the cathode electrode.

### Third Embodiment

Inside the enclosing tube, a plurality of cathode electrodes or anode electrodes may be formed. The following description describes the example where the plurality of cathode electrodes or anode electrodes is formed inside the enclosing tube.

### [Configuration of Geiger-Muller Counter Tube 110]

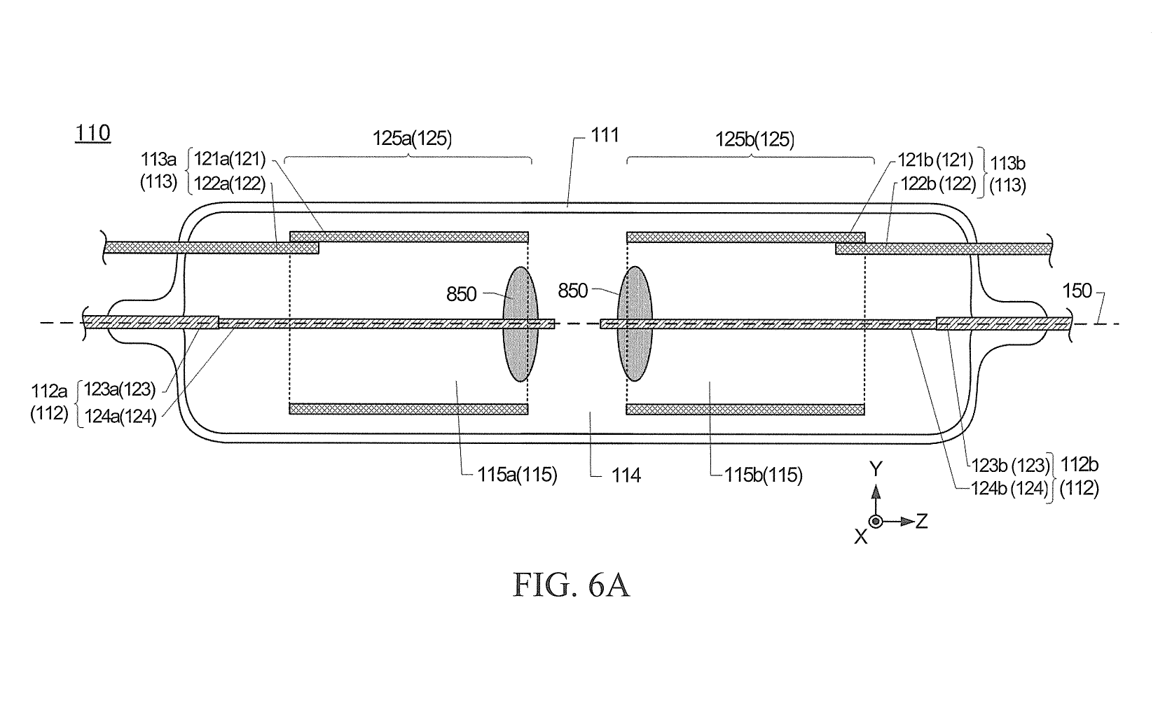

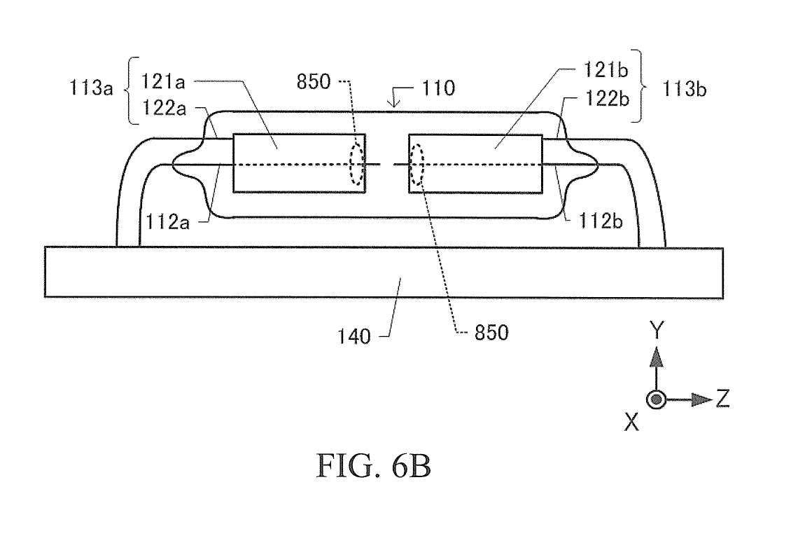

FIG. 6A is a sectional drawing of a Geiger-Muller counter tube 110. The Geiger-Muller counter tube 110 is constituted of an enclosing tube 111, an anode conductor 112, a cathode conductor 113, and the bead 850. In the following description, assume that the extending direction of the enclosing tube 111 is the Z-axis direction, the diametrical direction of the enclosing tube 111 which is perpendicular to the Z-axis direction is the X-axis direction. Similarly, assume that the diametrical direction of the enclosing tube 111 which is perpendicular to the X-axis direction and the Z-axis direction is the Y-axis direction.

The enclosing tube 111 is formed of glass in a cylindrical shape. Both ends of the +Z-axis side and the −Z-axis side of the enclosing tube 111 is sealed and a space 114 inside the enclosing tube 111 is sealed. The anode conductor 112 and the cathode conductor 113 pass through both end of the +Z-axis side and −Z-axis side of the enclosing tube 111.

The anode conductor 112 is constituted of an anode electrode 124 and a linear first metal lead portion 123. The anode electrode 124 which is rod-shaped is disposed in the space 114. The first metal lead portion 123 is connected to the anode electrode 124 and supported at the end of the enclosing tube 111. In the Geiger-Muller counter tube 110, the anode conductor 112 is constituted of a first anode conductor 112a and a second anode conductor 112b. The first anode conductor 112a is disposed in the −Z-axis side in the space 114, and the second anode conductor 112b is disposed in the +Z-axis side in the space 114. Further, the first anode conductor 112a is constituted of an anode electrode 124a and a first metal lead portion 123a, and the second anode conductor 112b is constituted of an anode electrode 124b and a first metal lead portion 123b. The first metal lead portion 123a is supported at the end of −Z-axis side of the enclosing tube 111 and the first metal lead portion 123b is supported at the end of +Z-axis side of the enclosing tube 111. Additionally, in the Geiger-Muller counter tube 110, the anode electrode 124a and the anode electrode 124b are disposed on the straight line 150 which extends in the Z-axis direction.

The cathode conductor 113 is constituted of a cylindrical cathode electrode 121 and a linear second metal lead portion 122. The cathode electrode 121 surrounds the peripheral area of the anode electrode 124 in the space 114. The second metal lead portion 122 is connected to the cathode electrode 121 and is supported at the end of the enclosing tube 111. The cathode electrode 121 is constituted of a cylindrical metal pipe. The metal pipe is formed of, for example, metallic Kovar that is an alloy of iron, nickel, and cobalt or stainless steel. The anode electrode 124 is disposed on the central axis of the cathode electrode 121. That is, the central axis of the cathode electrode 121 is disposed on the straight line 150. In the Geiger-Muller counter tube 110, the cathode conductor 113 is constituted of a first cathode conductor 113a and a second cathode conductor 113b. The first cathode conductor 113a is disposed in the −Z-axis side in the space 114 and the second cathode conductor 113b is disposed in the +Z-axis side in the space 114. Further, the first cathode conductor 113a is constituted of a cathode electrode 121a and a second metal lead portion 122a, and the second cathode conductor 113b is constituted of a cathode electrode 121b and a second metal lead portion 122b. The second metal lead portion 122a is supported at the end of −Z-axis side of the enclosing tube 111 and the second metal lead portion 122b is supported at the end of +Z-axis side of the enclosing tube 111.

In the Geiger-Muller counter tube 110, the bead 850 is mounted to the anode electrode 124 in the position where the anode electrode 124 is surrounded by the cathode electrode 121. The beads 850 are respectively mounted to the anode electrode 124a and anode electrode 124b, and are respectively disposed near the opening of the +Z-axis side of the cathode electrode 121a and near the opening of the −Z-axis side of the cathode electrode 121b.

A radiation detecting unit 125 which detects the radiation is constituted of the anode electrode 124 and the cathode electrode 121 which surrounds the anode electrode 124. In FIG. 6A, the radiation detecting unit 125 constituted of the anode electrode 124a and the cathode electrode 121a denotes a first radiation detecting unit 125a, and the radiation detecting unit 125 constituted of the anode electrode 124b and the cathode electrode 121b denotes a second radiation detecting unit 125b. In the Geiger-Muller counter tube 110, the radiation is detected at the first radiation detecting unit 125a and the second radiation detecting unit 125b respectively.

The radiation detecting unit 125 has a space 115 which is the space to detect the radiation. The space 115 is the space which is surrounded by the cathode electrode 121 and is the region which includes both the anode electrode 124 and the cathode electrode 121 inside an XY plane inside the space. In FIG. 6A, the space 115 of the first radiation detecting unit 125a denotes a space 115a and the space 115 of the second radiation detecting unit 125b denotes a space 115b.

In the Geiger-Muller counter tube, the radiation which enters into the space 115 is measured and thus, the detection sensitivity for the radiation can be increased by forming the space 115 larger. However, when the space 115 is formed larger by lengthening the anode electrode 124 and the cathode electrode 121, the fixed strength of the anode electrode 124 and the cathode electrode 121 in the space 115 is weakened. Therefore, the Geiger-Muller counter tube becomes susceptible to impact.

In the Geiger-Muller counter tube 110, the size of the space 115 is formed larger by forming the two sets of the respective pairs of anode electrodes 124 and cathode electrodes 121 in the space 114. Further, each of the anode electrode 124 and the cathode electrode 121 is secured at the −Z-axis side or the +Z-axis side of the Geiger-Muller counter tube 110. Therefore, the fixed strength of the anode electrode 124 and the cathode electrode 121 in the space 114 is increased. Thus, the impact resistance of the Geiger-Muller counter tube 110 is improved.

In addition, in the Geiger-Muller counter tube, the anode electrode is preferred to be disposed on the central axis of the cathode electrode but may deviate from the central axis in some cases. In this case, the variation of the characteristics of the Geiger-Muller counter tube may be caused. In particular, when the difference between the inside diameter of the cathode electrode and the outside diameter of the anode electrode becomes larger, the variation may become larger. In addition, in the manufacturing process, it is not easy to stably arrange the anode electrode on the central axis of the cathode electrode. In the Geiger-Muller counter tube 110, as illustrated in FIG. 6A, due to the mounting of the bead 850 to the anode electrode 124, the bead 850 keeps the gap between the anode electrode 124 and the cathode electrode 121 in a predetermined range. Thus, the anode electrode 124 is easily disposed near the central axis of the cathode electrode 121. Accordingly, the production of the Geiger-Muller counter tube is facilitated and the variation of the characteristics of the Geiger-Muller counter tube is suppressed.

In the Geiger-Muller counter tube 110, the bead 850 is disposed near the opening of the +Z-axis side of the cathode electrode 121a and near the opening of the −Z-axis side of the cathode electrode 121b. However, the positons to arrange the bead 850 are not limited to these positons, that is, the bead 850 may be disposed at any position in the region as long as the bead 850 is surrounded by the cathode electrode 121. Additionally, in FIG. 6A, the beads 850 may be additionally disposed at a plurality of positions of one anode electrode, such as near the opening of the −Z-axis side of the cathode electrode 121a and near the opening of the +Z-axis side of the cathode electrode 121b.

FIG. 6B is a schematic side view of the Geiger-Muller counter tube 110 mounted on a substrate 140. The Geiger-Muller counter tube 110 is used by being fixed to the substrate 140. In the conventional Geiger-Muller counter tube, electrodes are extracted only from one end of the enclosing tube, and only one end of the Geiger-Muller counter tube is secured to the substrate or a similar part. In contrast to this, in the Geiger-Muller counter tube 110, the electrodes are extracted from both ends of the enclosing tube 111. As illustrated in FIG. 6B, the Geiger-Muller counter tube 110 is secured to the substrate 140 at both ends of the +Z-axis side and the −Z-axis side of the Geiger-Muller counter tube 110. Therefore, the Geiger-Muller counter tube 110 can firmly and stably be secured to the substrate or a similar part compared to the conventional Geiger-Muller counter tubes.

In addition, in the Geiger-Muller counter tube 110, the measurement is performed in the state where the inert gas and the quenching gas are sealed in the space 114 and are not circulated. Therefore, the state in the space 114 is stabilized and the detection sensitivity of the radiations can be kept stable.

Furthermore, when using a plurality of Geiger-Muller counter tubes for the purpose such as increasing the detection sensitivity for the radiation, due to the individual difference of the detection sensitivity of each Geiger-Muller counter tubes, the accuracy of radiation detection may be lowered in some cases. In the Geiger-Muller counter tube 110, two sets of the radiation detecting unit 125 are disposed in one Geiger-Muller counter tube, and the inert gas and the quenching gas are commonly used. Accordingly, the ratio of the inert gas and the quenching gas inside the Geiger-Muller counter tube 110 is the same. Therefore, in the Geiger-Muller counter tube 110, the accuracy of radiation detection can be increased compared to using two sets of the Geiger-Muller counter tubes.

### [Configuration of Radiation Measurement Apparatus 100]

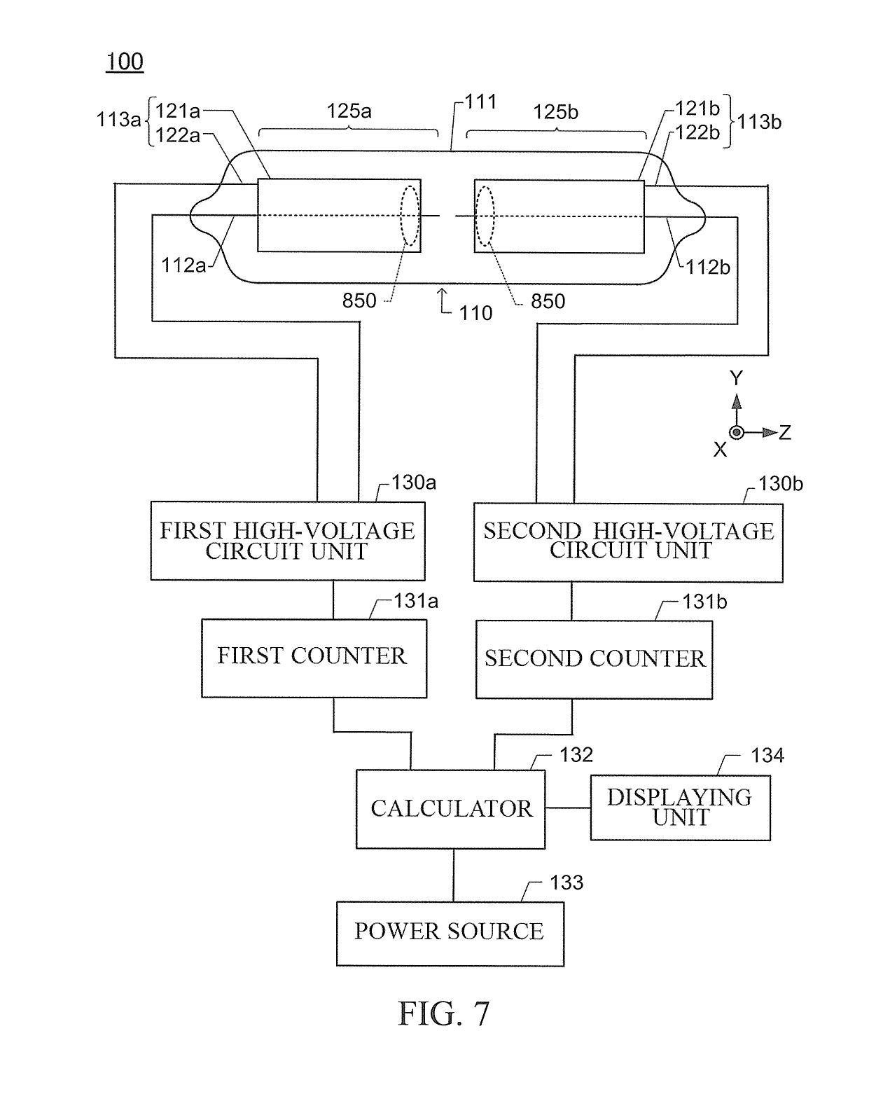

FIG. 7 is a schematic configuration diagram of a radiation measurement apparatus 100. The radiation measurement apparatus 100 is constituted including the Geiger-Muller counter tube 110. The first anode conductor 112a and the first cathode conductor 113a are connected to a first high-voltage circuit unit 130a and a high voltage is applied between both conductors. Further, the second anode conductor 112b and the second cathode conductor 113b are connected to a second high-voltage circuit unit 130b and a high voltage is applied between both conductors. The first high-voltage circuit unit 130a is connected to a first counter 131a. The second high-voltage circuit unit 130b is connected to a second counter 131b. The pulse signal detected by the first radiation detecting unit 125a and the second radiation detecting unit 125b of the Geiger-Muller counter tube 110 is counted by the first counter 131a and the second counter 131b and then converted into the radiation dose by a calculator 132. The converted radiation dose is displayed on a displaying unit 134. The calculator 132 connects to a power source 133 to receive the electric power.

In the radiation measurement apparatus 100 illustrated in FIG. 7, the first radiation detecting unit 125a and the second radiation detecting unit 125b are respectively connected to the different high-voltage circuit unit and counter, and detect the radiation dose individually. However, the first radiation detecting unit 125a and the second radiation detecting unit 125b may be connected in parallel to one high-voltage circuit unit and one counter. Thus, the first radiation detecting unit 125a and the second radiation detecting unit 125b may detect the radiation dose as a whole.

### Fourth Embodiment

The radiation dose detected by the Geiger-Muller counter tube 110 is measured as the total value of the radiation dose of both β-ray and γ-ray. On the other hand, it is required to measure each radiation dose of β-ray and γ-ray in some cases. The following description describes a Geiger-Muller counter tube 210 and a radiation measurement apparatus 200 to measure each radiation dose of β-ray and γ-ray. Additionally, like reference numerals designate corresponding or identical elements throughout the second embodiment, and therefore such elements will not be further elaborated here.

### [Configuration of Geiger-Muller Counter Tube 210]

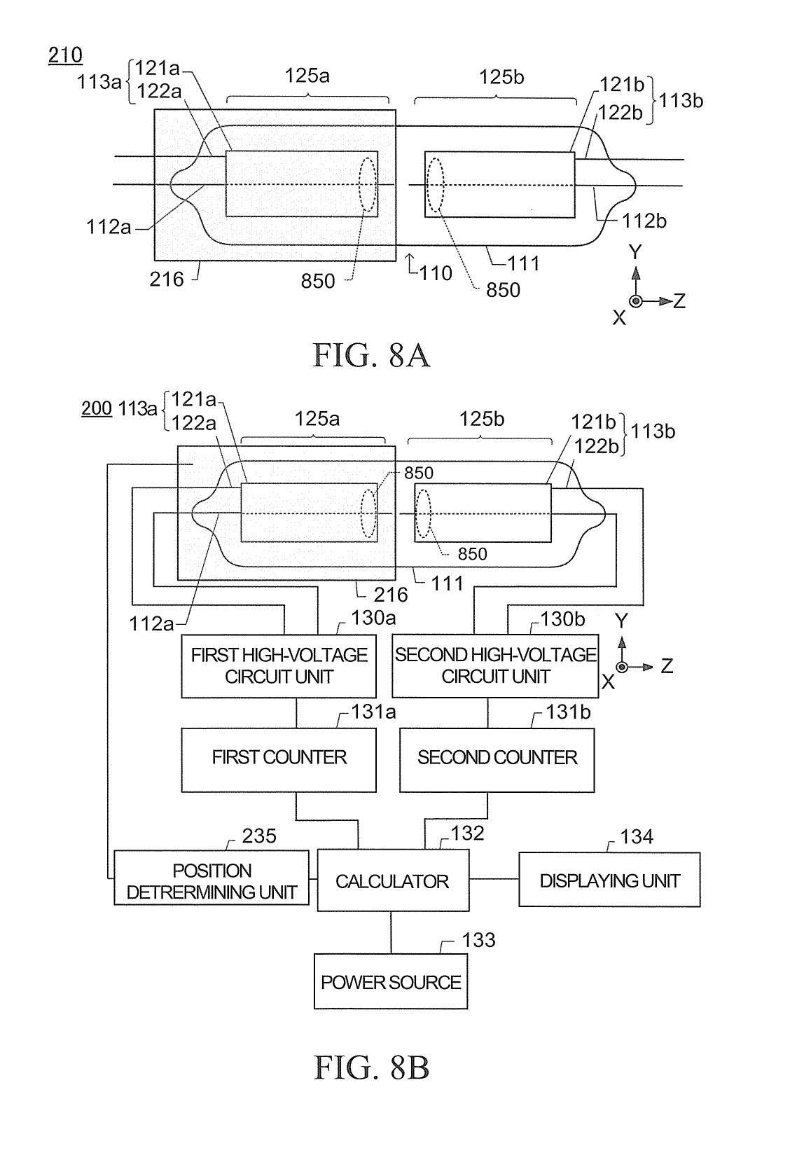

FIG. 8A is a schematic configuration diagram of the Geiger-Muller counter tube 210. The Geiger-Muller counter tube 210 is formed in the state where a shielding portion 216 is mounted to the first radiation detecting unit 125a of the Geiger-Muller counter tube 110. The shielding portion 216 blocks β-ray by surrounding the enclosing tube 111 from the outside. The shielding portion 216 can be formed, for example, as a cylindrical tube of aluminum.

In the Geiger-Muller counter tube 210, the second radiation detecting unit 125b, which is not covered by the shielding portion 216, can detect β-ray and γ-ray. In addition, the first radiation detecting unit 125a, which is covered with the shielding portion 216, can detect only γ-ray because β-ray is blocked by the shielding portion 216. The radiation dose of β-ray can be obtained by subtracting the radiation dose of the first radiation detecting unit 125a from the radiation dose of the second radiation detecting unit 125b.

Conventionally, two Geiger-Muller counter tubes are prepared when measuring β-ray and γ-ray simultaneously. One Geiger-Muller counter tube is put into a tube such as an aluminum tube to block β-ray and measures only γ-ray. In addition, the other Geiger-Muller counter tube measures β-ray and γ-ray. Then, β-ray is obtained by subtracting the radiation dose of the one Geiger-Muller counter tube from the radiation dose of the other Geiger-Muller counter tube.

In contrast to this, in the Geiger-Muller counter tube 210, both radiation dose of β-ray and γ-ray can be measured simultaneously with one Geiger-Muller counter tube. Therefore, it is possible to save a labor to prepare a plurality of Geiger-Muller counter tubes and thus, the measurement is facilitated. Furthermore, similar to the Geiger-Muller counter tube 110, the inert gas and the quenching gas are commonly used in the first radiation detecting unit 125a and the second radiation detecting unit 125b. Therefore, the accuracy of radiation detection can be increased compared to using two sets of the Geiger-Muller counter tubes.

### [Configuration of Radiation Measurement Apparatus 200]

FIG. 8B is a schematic configuration diagram of the radiation measurement apparatus 200. In the radiation measurement apparatus 200, the Geiger-Muller counter tube 210 is employed instead of the Geiger-Muller counter tube 110 in the radiation measurement apparatus 100 illustrated in FIG. 7. Further, a position determining unit 235 for determining the position of the shielding portion 216 is included. In the state illustrated in FIG. 8B, the radiation dose of only γ-ray is detected at the first counter 131a which is connected to the first radiation detecting unit 125a shielded by the shielding portion 216. Additionally, the radiation dose of γ-ray and β-ray are detected at the second counter 131b which is connected to the second radiation detecting unit 125b. Therefore, in the radiation measurement apparatus 200, the radiation dose of γ-ray can be detected by the radiation dose of the first radiation detecting unit 125a. Further, the radiation dose of β-ray can be detected by subtracting the radiation dose of the first radiation detecting unit 125a from the radiation dose of the second radiation detecting unit 125b. These calculations are performed at the calculator 132, and further, the result can be displayed on the displaying unit 134.

In addition, in the radiation measurement apparatus 200, the shielding portion 216 is formed so as to be able to freely remove from and/or mount to the first radiation detecting unit 125a. For example, when the shielding portion 216 is moved to the −Z-axis direction from the state of FIG. 8B, the first radiation detecting unit 125a becomes exposed. Then, the first radiation detecting unit 125a and the second radiation detecting unit 125b can perform measurement in the same condition. When the measurement is performed in this state, it is possible to perform proofread of the detected value of the radiation dose between the first radiation detecting unit 125a and the second radiation detecting unit 125b or a similar operation.

Furthermore, in the shielding portion 216, for example, a sensor (not illustrated), which senses whether the shielding portion 216 is removed from or mounted to the Geiger-Muller counter tube 210 may be included. Thus, removal/mounting of the shielding portion 216 may be determined automatically. The sensor is connected to the position determining unit 235 which determines the position of the shielding portion 216, and the position determining unit 235 is connected to the calculator 132. In the calculator 132, when the position determining unit 235 determines that the shielding portion 216 is mounted to the Geiger-Muller counter tube 210, γ-ray is detected by the first radiation detecting unit 125a. Then, β-ray is automatically detected by subtracting the radiation dose of the first radiation detecting unit 125a from that of the second radiation detecting unit 125b. Furthermore, when the position determining unit 235 determines that the shielding portion 216 is removed from the Geiger-Muller counter tube 210, the radiation doses of the first radiation detecting unit 125a and the second radiation detecting unit 125b are displayed on the displaying unit 134. In the display on the displaying unit 134, an arithmetic mean of the radiation doses of the first radiation detecting unit 125a and the second radiation detecting unit 125b may be displayed.

### Fifth Embodiment

In the Geiger-Muller counter tube, only either one of the cathode conductor or the anode conductor may be formed in two sets. The following description describes the Geiger-Muller counter tube where only either one of the cathode conductor or the anode conductor is formed in two sets.

Additionally, like reference numerals designate corresponding or identical elements throughout the first embodiment and the second embodiment, and therefore such elements will not be further elaborated here.

### [Configuration of Geiger-Muller Counter Tube 310]

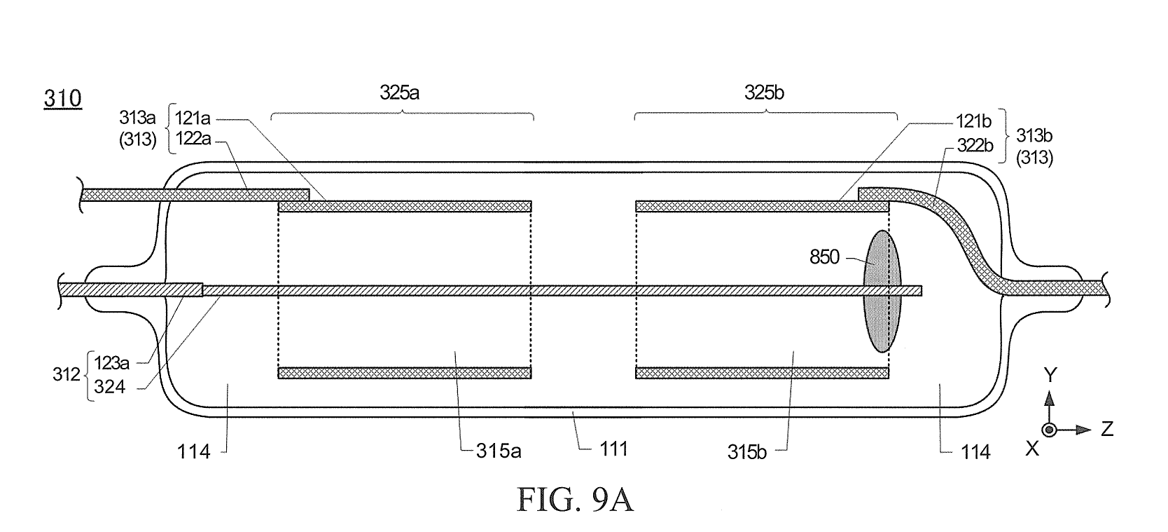

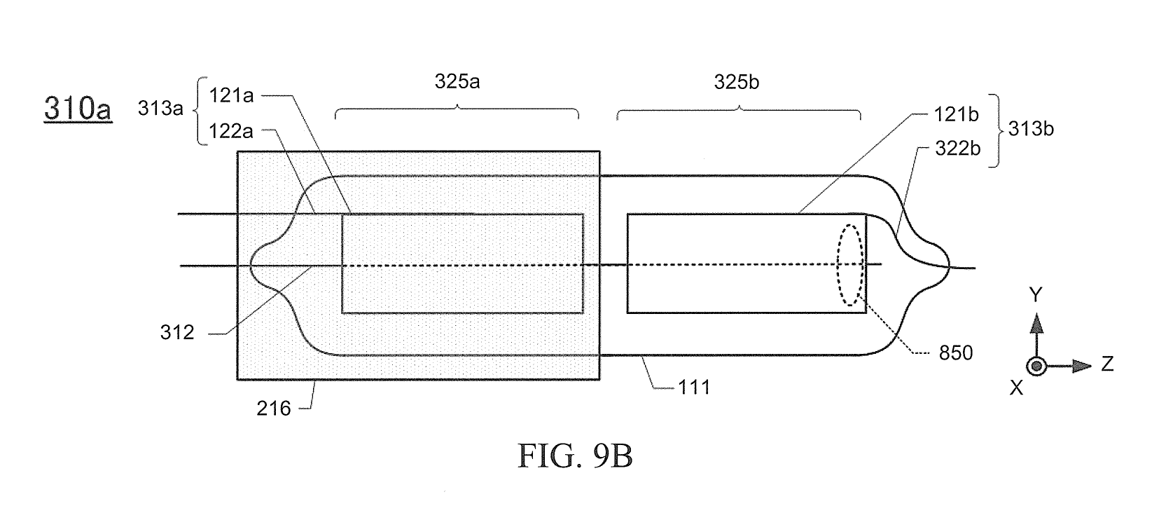

FIG. 9A is a sectional drawing of the Geiger-Muller counter tube 310 The Geiger-Muller counter tube 310 is constituted of the enclosing tube 111, an anode conductor 312, and a cathode conductor 313, and the bead 850.

The anode conductor 312 is constituted of an anode electrode 324 and the linear first metal lead portion 123a. The anode electrode 324 is disposed in the space 114. The first metal lead portion 123a is connected to the anode electrode 324 and supported at the end of the −Z-axis side the enclosing tube 111. The end of the −Z-axis side of the anode electrode 324 is connected to the first metal lead portion 123a. The end of the +Z-axis side of the anode electrode 324 extends in the Z-axis direction up to near the end of the +Z-axis side in the space 114.

The cathode conductor 313 is constituted of a first cathode conductor 313a which is disposed in the −Z-axis side in the space 114 and a second cathode conductor 313b which is disposed in the +Z-axis side in the space 114. The first cathode conductor 313a is constituted of the cathode electrode 121a and the second metal lead portion 122a, and the second metal lead portion 122a is bonded on the outer surface of the cathode electrode 121a. The second cathode conductor 313b is constituted of the cathode electrode 121b and a second metal lead portion 322b, and the second metal lead portion 322b is bonded on the outer surface of the cathode electrode 121b. Further, the second metal lead portion 322b is supported at the center of the end of the +Z-axis side of the enclosing tube 111.

In the Geiger-Muller counter tube 310, a first radiation detecting unit 325a is constituted of the cathode electrode 121a and the anode electrode 324, and a second radiation detecting unit 325b is constituted of the cathode electrode 121b and the anode electrode 324. The first radiation detecting unit 325a has a space 315a which detects the radiation, and the second radiation detecting unit 325b has a space 315b which detects the radiation. In addition, the bead 850 mounted to the anode electrode 324 is disposed near the opening of the +Z-axis side of the cathode electrode 121b inside the space 315b. Accordingly, the anode electrode 324 is disposed on or near the central axis of the cathode electrode 121a and the cathode electrode 121b.

In the anode electrode 324, the ionized electrons, which are generated at the first radiation detecting unit 325a and the second radiation detecting unit 325b, are detected. Accordingly, by measuring the pulse signals detected at the anode electrode 324, the total radiation dose of β-ray and γ-ray, which are detected at the first radiation detecting unit 325a and the second radiation detecting unit 325b, can be measured.

In each radiation detecting unit, the ionized ions receive the electrons in the cathode electrode 121 and the pulse current flows to the cathode electrode 121. The radiation dose can be measured by measuring this pulse current. In the cathode electrode 121a and the cathode electrode 121b, the respective total radiation doses of β-ray and γ-ray is measured at the first radiation detecting unit 325a and the second radiation detecting unit 325b.

In the Geiger-Muller counter tube 310, the whole radiation dose of the first radiation detecting unit 325a and the second radiation detecting unit 325b is measured by the anode electrode 324. Further, at the same time, the radiation dose of the first radiation detecting unit 325a and the second radiation detecting unit 325b can be individually measured by each cathode electrode. Additionally, in the Geiger-Muller counter tube 310, despite the capability of performing such individual measurement, assembly of the Geiger-Muller counter tube 310 is facilitated because the usage of the anode electrode 324 is one.

Further, in the cathode conductor 313, the second metal lead portion 122a and the second metal lead portion 322b are bonded on the outer surfaces of the cathode electrode 121a and the cathode electrode 121b respectively. Therefore, the gap between the anode electrode and the cathode electrode is constant at any position in the space 315a and the space 315b where the radiation is detected. Accordingly, unevenness of the discharge conditions in the space 315a and the space 315b is eliminated and more accurate measurement can be performed. In addition, the configuration such as bonding the metal lead portion on the outer surface of the cathode electrode may be employed to the aforementioned Geiger-Muller counter tube 110 and a Geiger-Muller counter tube 410 described below or similar Geiger-Muller counter tubes.

### [Configuration of Geiger-Muller Counter Tube 310a]

FIG. 9B is a schematic sectional drawing of the Geiger-Muller counter tube 310a. The Geiger-Muller counter tube 310a is constituted of the Geiger-Muller counter tube 310 and the shielding portion 216 which covers the first radiation detecting unit 325a of the Geiger-Muller counter tube 310.

In the first radiation detecting unit 325a, only γ-ray is detected. Therefore, the radiation dose of γ-ray can be detected by measuring the pulse signal observed at the cathode electrode 121a. Additionally, the radiation dose of β-ray can be measured by subtracting the radiation dose detected at the cathode electrode 121a from the radiation dose detected at the cathode electrode 121b.

Furthermore, with the use of the Geiger-Muller counter tube 310a, a radiation measurement apparatus, where removal/mounting of the shielding portion 216 can be freely performed, can be formed, similar to the radiation measurement apparatus 200 illustrated in FIG. 8B.

### [Configuration of Geiger-Muller Counter Tube 410]

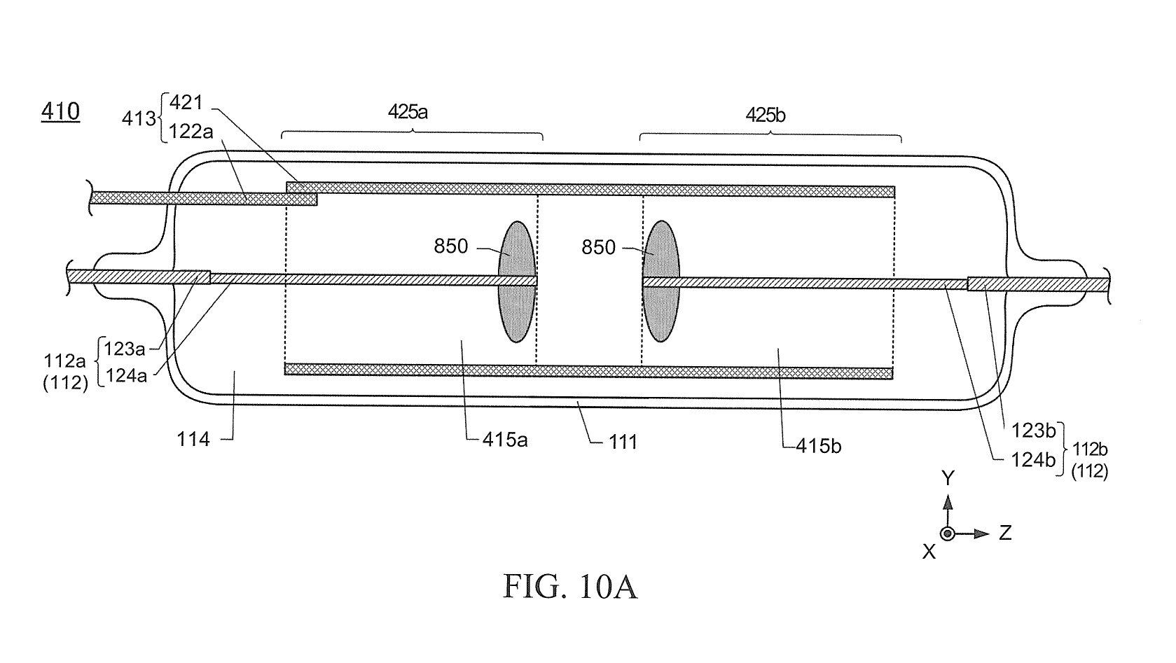

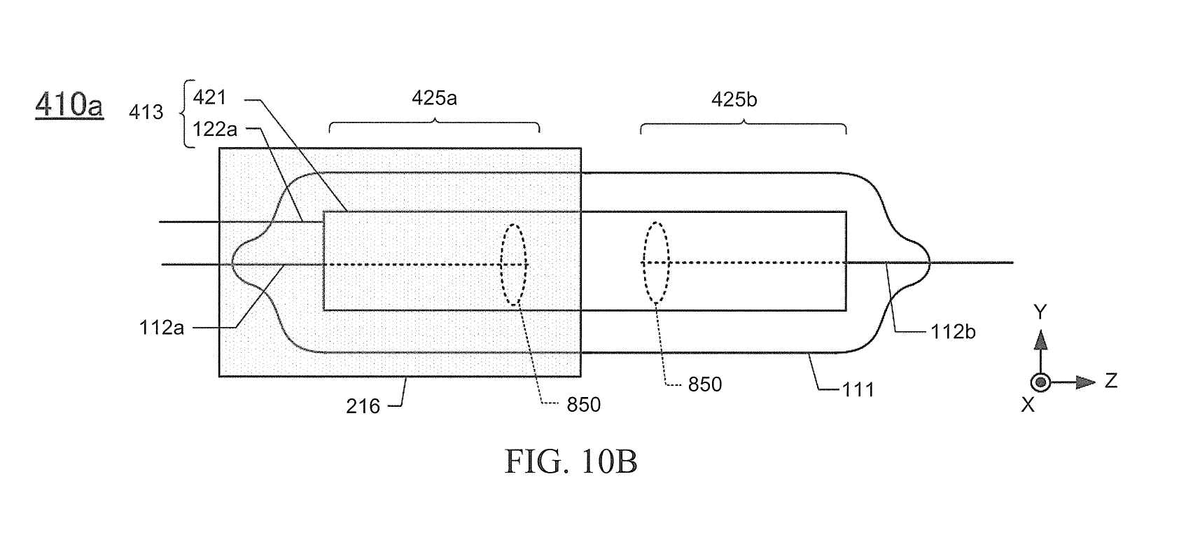

FIG. 10A is a sectional drawing of the Geiger-Muller counter tube 410. The Geiger-Muller counter tube 410 is constituted of the enclosing tube 111, the anode conductor 112, a cathode conductor 413, and the bead 850.

The cathode conductor 413 is constituted of a cathode electrode 421 and the second metal lead portion 122a. The second metal lead portion 122a passes through the end of the −Z-axis side of the enclosing tube 111 and holds the cathode electrode 421. The cathode electrode 421 is disposed so as to extend in the Z-axis direction in the space 114. The cathode electrode 421 extends from near the end of the −Z-axis side to near the end of the +Z-axis side in the space 114.

The anode conductor 112 is constituted of the first anode conductor 112a and the second anode conductor 112b, similar to the Geiger-Muller counter tube 110 illustrated in FIG. 6A. Both of the anode electrode 124a of the first anode conductor 112a and the anode electrode 124b of the second anode conductor 112b are disposed on the central axis of the cathode electrode 421.

In the Geiger-Muller counter tube 410, assume that the portion where the cathode electrode 421 and the anode electrode 124a are overlapped in the XY plane is a first radiation detecting unit 425a. Further, assume that the portion where the cathode electrode 421 and the anode electrode 124b are overlapped in the XY plane is a second radiation detecting unit 425b. In addition, assume that the space where the first radiation detecting unit 425a detects the radiation is a space 415a and the space where the second radiation detecting unit 425b detects the radiation is a space 415b. Further, in the +Z-axis side inside the space 415a and the −Z-axis side inside the space 415b, the beads 850 are mounted to the anode electrode 124a and the anode electrode 124b.

In the Geiger-Muller counter tube 410, the total radiation dose of the first radiation detecting unit 425a and the second radiation detecting unit 425b is detected by the cathode electrode 421. Additionally, the total radiation dose of β-ray and γ-ray at the first radiation detecting unit 425a can be detected by the anode electrode 124a, and the total radiation dose of β-ray and -γ-ray at the second radiation detecting unit 425b can be detected by the anode electrode 124b. Furthermore, in the Geiger-Muller counter tube 410, despite the capability of performing such a plurality of the radiation-dose-measurement simultaneously, assembly of the Geiger-Muller counter tube 410 is facilitated because the usage of the cathode electrode 421 is one.

Furthermore, in the Geiger-Muller counter tube 410, because each anode electrode 124 is surrounded by the cathode electrode 421, the position of the anode electrode 124 cannot be confirmed. However, each anode electrode 124 can be disposed so as not to deviate largely from the central axis of the cathode electrode 421 due to the mounting of the bead 850 to each anode electrode 124.

### [Configuration of Geiger-Muller Counter Tube 410a]

FIG. 10B is a schematic sectional drawing of a Geiger-Muller counter tube 410a. The Geiger-Muller counter tube 410a is constituted of the Geiger-Muller counter tube 410 and the shielding portion 216 which covers the first radiation detecting unit 425a of the Geiger-Muller counter tube 410.

In the first radiation detecting unit 425a, only γ-ray is detected. Therefore, the radiation dose of γ-ray can be detected by measuring the pulse signal observed at the anode electrode 124a. Additionally, the radiation dose of β-ray can be measured by subtracting the radiation dose detected at the anode electrode 124a from the radiation dose detected at the anode electrode 124b.

Furthermore, with the use of the Geiger-Muller counter tube 410a, a radiation measurement apparatus, where removal/mounting of the shielding portion 216 can be freely performed, can be formed, similar to the radiation measurement apparatus 200 illustrated in FIG. 8B.

### Sixth Embodiment

In the radiation measurement apparatus 100, the first radiation detecting unit 125a and the second radiation detecting unit 125b are connected to the first high-voltage circuit unit 130a and the second high-voltage circuit unit 130b respectively. However, the first radiation detecting unit 125a and the second radiation detecting unit 125b may be connected to one high-voltage circuit unit together. The following description describes the radiation measurement apparatus which includes a plurality of radiation measurement units and one high-voltage circuit unit. Additionally, like reference numerals designate corresponding or identical elements throughout the third to fifth embodiments, and therefore such elements will not be further elaborated here.

### [Configuration of Radiation Measurement Apparatus 500]

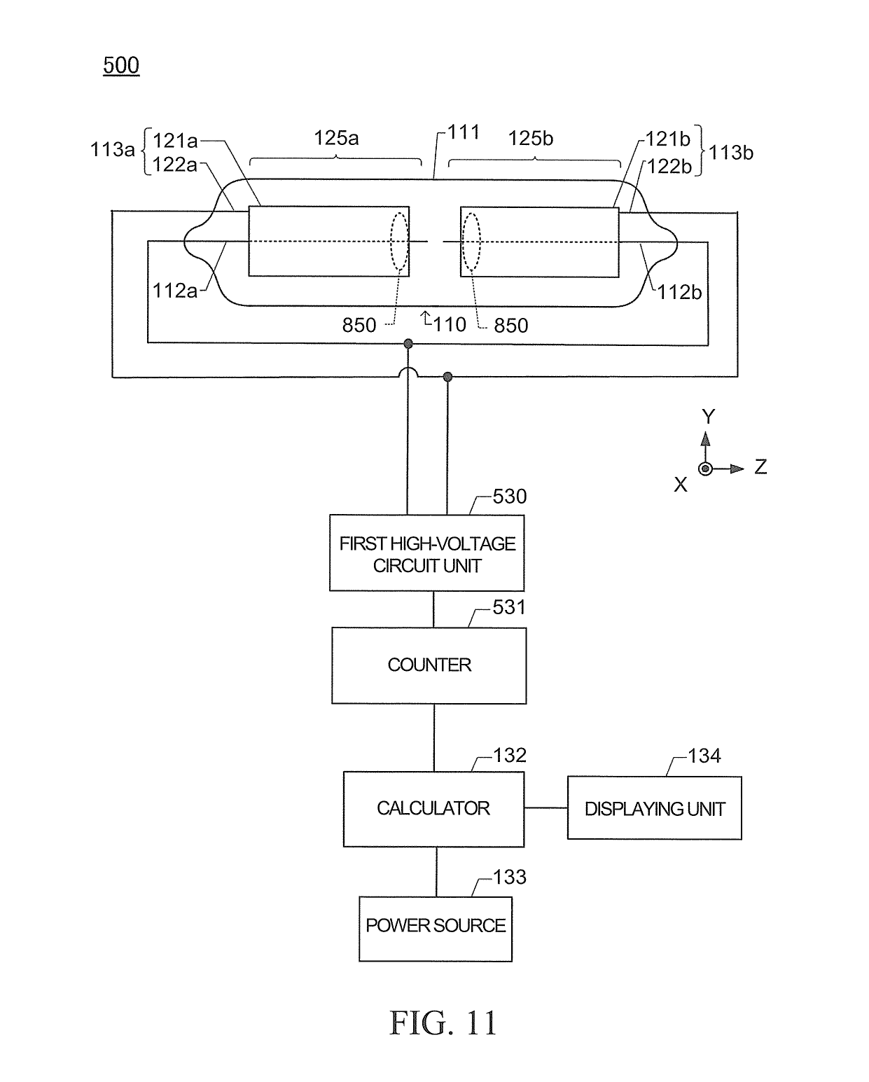

FIG. 11 is a schematic configuration diagram of a radiation measurement apparatus 500. The radiation measurement apparatus 500 is constituted including the Geiger-Muller counter tube 110, a high-voltage circuit unit 530, a counter 531, the calculator 132, the displaying unit 134, and the power source 133. The high-voltage circuit unit 530 has similar performance with the first high-voltage circuit unit 130a and the second high-voltage circuit unit 130b. The counter 531 has similar performance with the first counter 131a and the second counter 131b.

The first anode conductor 112a and the second anode conductor 112b of the Geiger-Muller counter tube 110 are connected together, and connected to the high-voltage circuit unit 530. In addition, the first cathode conductor 113a and the second cathode conductor 113b are connected together, and connected to the high-voltage circuit unit 530. That is, the first radiation detecting unit 125a and the second radiation detecting unit 125b are connected in parallel with respect to the high-voltage circuit unit 530.

The counter 531 is connected to the high-voltage circuit unit 530, and the pulse signals detected by the first radiation detecting unit 125a and the second radiation detecting unit 125b are counted by the counter 531. That is, in the counter 531, the total of the pulse signals detected by the first radiation detecting unit 125a and the second radiation detecting unit 125b is detected. The calculator 132 is connected to the counter 531, and the power source 133 and the displaying unit 134 is connected to the calculator 132.

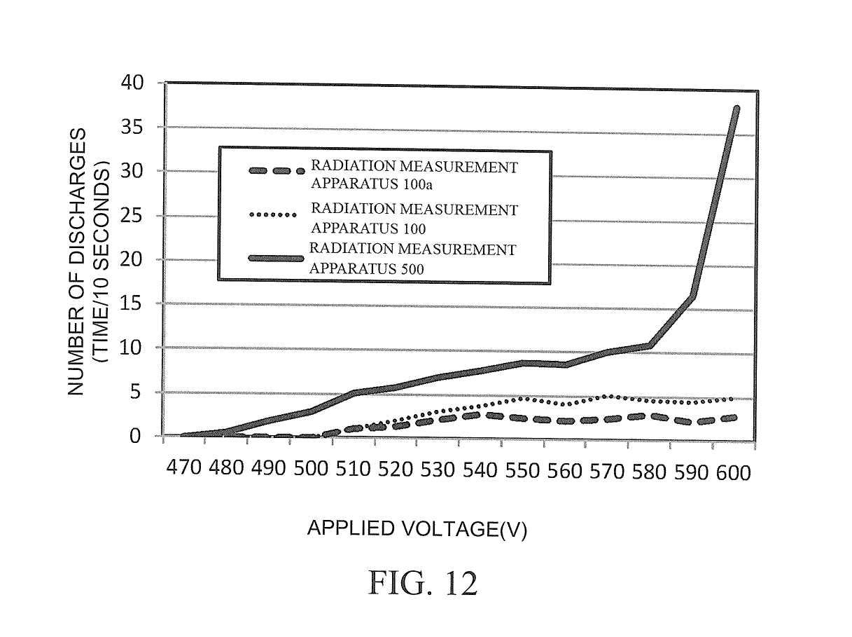

FIG. 12 is a graph that compares the number of discharges of radiation measurement apparatuses. In FIG. 12, the relationship between the number of discharges of the three radiation measurement apparatuses and applied voltages is illustrated. The three radiation measurement apparatuses are as follows: the radiation measurement apparatus 500 (see FIG. 11), the radiation measurement apparatus 100 (see FIG. 7), and a radiation measurement apparatus 100a. The radiation measurement apparatus 100a is the radiation measurement apparatus where, in the radiation measurement apparatus 100 (see FIG. 7), the electrode of the second radiation detecting unit 125b is opened. Thus, the measurement is performed with only the first radiation detecting unit 125a. The vertical axis of FIG. 12 denotes the number of discharges of the entire Geiger-Muller counter tube of each radiation measurement apparatus. The number of discharges is denoted as the number of discharges per 10 seconds. Further, the horizontal axis of FIG. 12 denotes the magnitude of the applied voltages which are applied between the anode electrode and the cathode electrode of the Geiger-Muller counter tube. The applied voltage is DC voltage, and a unit is volt (V).

In FIG. 12, the number of discharges of the radiation measurement apparatus 100a increases between 500V to 530V in applied voltage and stabilizes when the applied voltage becomes larger than 530V. The number of discharges of the radiation measurement apparatus 100 increases between 500V to 540V in applied voltage and stabilizes when the applied voltage becomes larger than 530V. In the radiation measurement apparatus 500, the number of discharges increases between 480V to 510V in applied voltage. Further, the number of discharges increases gradually between 510V to 580V in applied voltage and increases significantly when the applied voltage becomes larger than 580V.

For the comparison of each radiation measurement apparatus, the number of discharges is compared when the applied voltage is 550V. The results of the number of discharges of each radiation measurement apparatus are as follows, i.e., 2.4 times/10 seconds in the radiation measurement apparatus 100a, 4.7 times/10 seconds in the radiation measurement apparatus 100, 8.7 times/10 seconds in the radiation measurement apparatus 500. In this case, the radiation measurement apparatus 100 detects about two times as many as the pulse signal with respect to the radiation measurement apparatus 100a. Further, the radiation measurement apparatus 500 detects about 1.9 times as many as the pulse signal with respect to the radiation measurement apparatus 100, and about 3.6 times as many as the pulse signal with respect to the radiation measurement apparatus 100a. That is, among the three radiation measurement apparatuses illustrated in FIG. 12, the radiation-detection sensitivity of the radiation measurement apparatus 100a is the lowest and that of the radiation measurement apparatus 500 is the highest.

The main difference between the radiation measurement apparatus 100 and radiation measurement apparatus 500 is the number of usage of the high-voltage circuit unit and the counter. Therefore, the difference of the radiation-detection sensitivity between the radiation measurement apparatus 100 and radiation measurement apparatus 500 illustrated in FIG. 12 is very likely caused by the number of usage of the high-voltage circuit unit and the counter. Furthermore, because the counter only counts the pulse signal, it is very likely that the number of usage of the high-voltage circuit unit significantly affects the difference of the radiation-detection sensitivity.

As indicated in the radiation measurement apparatus 500 in FIG. 12, using one high-voltage circuit unit can increase the radiation-detection sensitivity compared to using a plurality of high-voltage circuit units. Furthermore, in the radiation measurement apparatus 500, the number of usage of the high-voltage circuit unit and the counter is only one respectively. Thus, the number of components for the radiation measurement apparatus becomes fewer, and manufacturing cost is lowered, which is preferred.

### [Configuration of Radiation Measurement Apparatus 600]

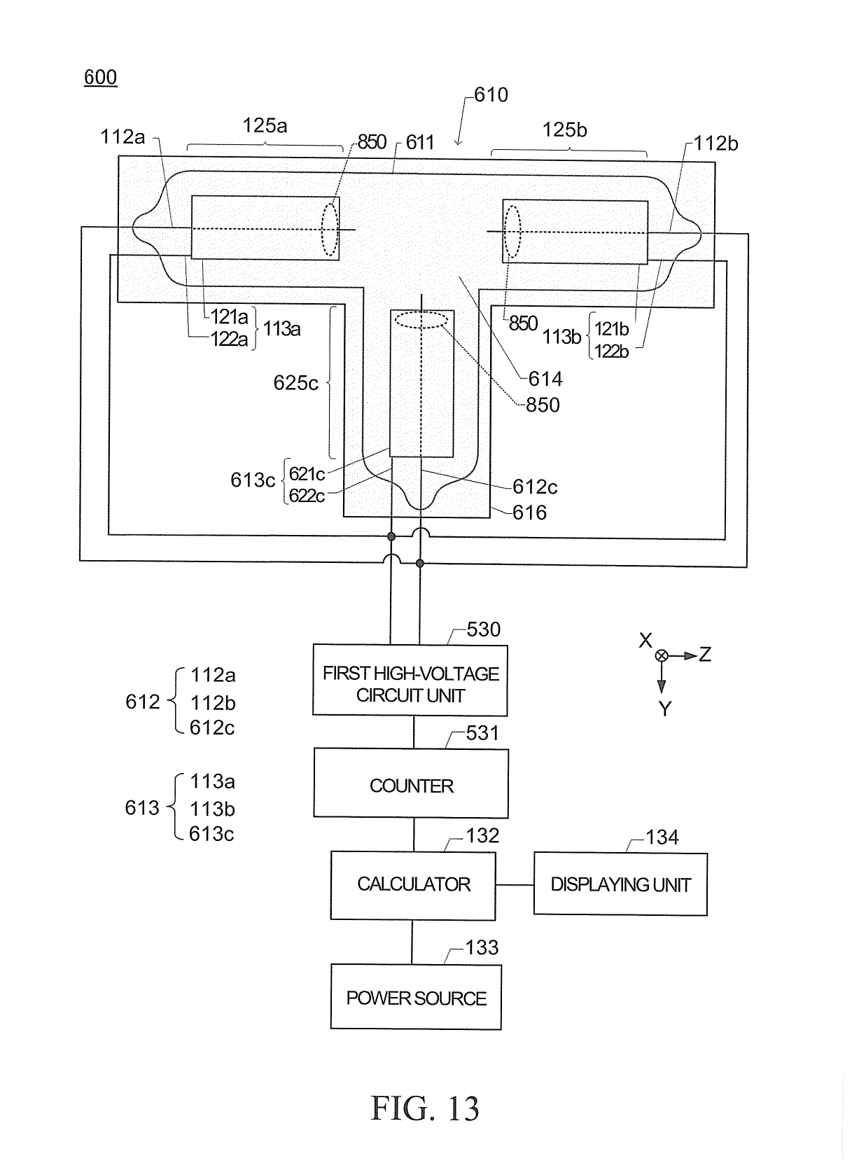

FIG. 13 is a schematic configuration diagram of a radiation measurement apparatus 600. The radiation measurement apparatus 600 is constituted including a Geiger-Muller counter tube 610, the high-voltage circuit unit 530, the counter 531, the calculator 132, the displaying unit 134, and the power source 133.

The Geiger-Muller counter tube 610 is constituted of an enclosing tube 611, an anode conductor 612, and a cathode conductor 613 and the bead 850. In the enclosing tube 611, a cylindrical glass tube is formed so as to extend in the +Z-axis direction, −Z-axis direction, and +Y-axis direction respectively. A space 614 inside the enclosing tube 611 is sealed.

The anode conductor 612 is constituted of the first anode conductor 112a, the second anode conductor 112b, and a third anode conductor 612c. The third anode conductor 612c is constituted of the anode electrode (not illustrated) and the first metal lead portion (not illustrated), and the anode electrode is disposed inside the space which extends in the +Y-axis direction in the enclosing tube 611. The third anode conductor 612c is formed in the same shape with the first anode conductor 112a and the second anode conductor 112b. The third anode conductor 612c is different from the first anode conductor 112a and the second anode conductor 112b only in an arrangement position inside the enclosing tube 611. The third anode conductor 612c is secured to the enclosing tube 611 by being supported at the end of the +Y-axis side of the enclosing tube 611.

The cathode conductor 613 is constituted of the first cathode conductor 113a, the second cathode conductor 113b, and a third cathode conductor 613c. The third cathode conductor 613c is constituted of a cathode electrode 621c and a second metal lead portion 622c, and is disposed in the space which extends in the +Y-axis direction in the enclosing tube 611. The third cathode conductor 613c has the same shape with the first cathode conductor 113a and the second cathode conductor 113b. The third cathode conductor 613c is different from the first cathode conductor 113a and the second cathode conductor 113b only in an arrangement position inside the enclosing tube 611. The third cathode conductor 613c is secured to the enclosing tube 611 with the second metal lead portion 622c being supported at the end of the +Y-axis side of the enclosing tube 611.

The Geiger-Muller counter tube 610 includes a third radiation detecting unit 625c which is constituted of the third anode conductor 612c and the third cathode conductor 613c together with the inclusion of the first radiation detecting unit 125a and the second radiation detecting unit 125b. The third radiation detecting unit 625c is the radiation detecting unit which is formed in the similar shape with the first radiation detecting unit 125a and the second radiation detecting unit 125b. The third radiation detecting unit 625c is different from the first radiation detecting unit 125a and the second radiation detecting unit 125b only in an arrangement position inside the enclosing tube 611. Furthermore, in the +Z-axis side of the first radiation detecting unit 125a, −Z-axis side of the second radiation detecting unit 125b, and −Y-axis side of the third radiation detecting unit 625c, the beads 850 are disposed by being mounted to the anode electrodes which constitute each detecting unit.

In the radiation measurement apparatus 600, the first cathode conductor 113a, the second cathode conductor 113b, and the third cathode conductor 613c of the Geiger-Muller counter tube 610 are electrically connected together and are connected to the high-voltage circuit unit 530. Further, the first anode conductor 112a, the second anode conductor 112b, and the third anode conductor 612c are electrically connected together and are connected to the high-voltage circuit unit 530. That is, the first radiation detecting unit 125a, the second radiation detecting unit 125b, and the third radiation detecting unit 625c are connected in parallel with respect to the high-voltage circuit unit 530.

The counter 531 is connected to the high-voltage circuit unit 530. The pulse signals detected by the first radiation detecting unit 125a, the second radiation detecting unit 125b, and the third radiation detecting unit 625c are counted by the counter 531. That is, the counter 531 counts the total of the pulse signals detected by the first radiation detecting unit 125a, the second radiation detecting unit 125b, and the third radiation detecting unit 625c. The calculator 132 is connected to the counter 531, and the power source 133 and the displaying unit 134 is connected to the calculator 132.

In the radiation measurement apparatus 600, as illustrated in FIG. 13, a shielding portion 616 which blocks β-ray can be mounted to the enclosing tube 611 so as to surround the enclosing tube 611 from the outside. Thus, the radiation measurement apparatus 600 can measure both β-ray and γ-ray. This measurement, for example, can be performed as follows: the total value of β-ray and γ-ray is measured by performing the measurement without mounting the shielding portion 616; further, the value of γ-ray is measured by performing the measurement with mounting the shielding portion 616; and then, the value of β-ray is calculated by subtracting the value of γ-ray from the total value of β-ray and γ-ray.

In the radiation measurement apparatus 600, the radiation-detection sensitivity becomes higher than the radiation measurement apparatus 500 due to including the three radiation detecting units. In addition, with the use of the shielding portion 616, each value of β-ray and γ-ray can be measured. In the radiation measurement apparatus 600, instead of measuring β-ray and γ-ray simultaneously, β-ray can be measured with high radiation-detection sensitivity due to the high radiation-detection sensitivity of the radiation measurement apparatus itself.

### [Configuration of Radiation Measurement Apparatus 700]

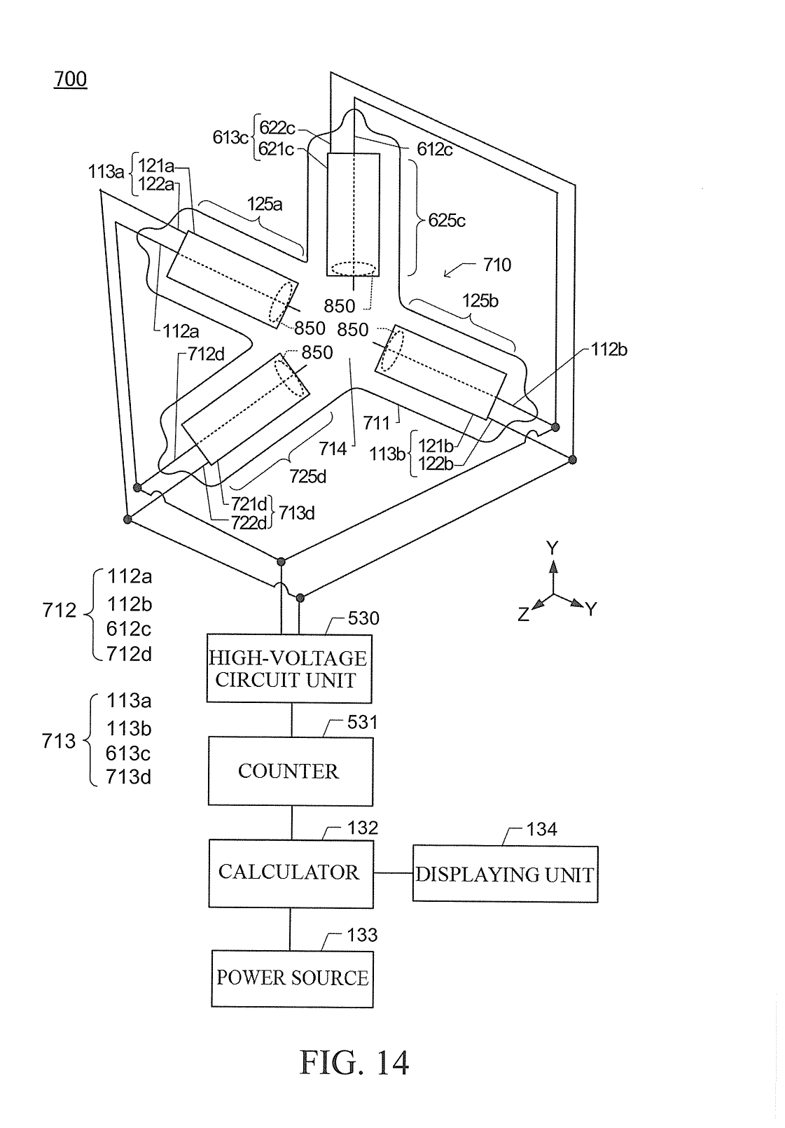

FIG. 14 is a schematic configuration diagram of the radiation measurement apparatus 700. The radiation measurement apparatus 700 is constituted including a Geiger-Muller counter tube 710, the high-voltage circuit unit 530, the counter 531, the calculator 132, the displaying unit 134, and the power source 133.

The Geiger-Muller counter tube 710 is constituted of an enclosing tube 711, an anode conductor 712, a cathode conductor 713, and the bead 850. In the enclosing tube 711, a cylindrical glass tube is formed so as to extend in the +Z-axis direction, −Z-axis direction, +Y-axis direction, and +X-axis direction respectively. A space 714 inside the enclosing tube 711 is sealed.

The anode conductor 712 is constituted of the first anode conductor 112a, the second anode conductor 112b, the third anode conductor 612c, and a fourth anode conductor 712d. The fourth anode conductor 712d is constituted of the anode electrode (not illustrated) and the first metal lead portion (not illustrated), and is disposed inside a space which extends in the +X-axis direction in the enclosing tube 711. The fourth anode conductor 712d has the same shape with the first anode conductor 112a and the second anode conductor 112b. The fourth anode conductor 712d is different from the first anode conductor 112a and the second anode conductor 112b only in an arrangement position inside the enclosing tube 711. The fourth anode conductor 712d is secured to the enclosing tube 711 by being supported at the end of the +X-axis side of the enclosing tube 711.

The cathode conductor 713 is constituted of the first cathode conductor 113a, the second cathode conductor 113b, the third cathode conductor 613c, and a fourth cathode conductor 713d. The fourth cathode conductor 713d is constituted of a cathode electrode 721d and a second metal lead portion 722d, and is disposed inside the space which extends in the +X-axis direction in the enclosing tube 711. The fourth cathode conductor 713d has the same shape with the first cathode conductor 113a and the second cathode conductor 113b. The fourth cathode conductor 713d is different from the first cathode conductor 113a and the second cathode conductor 113b only in an arrangement position inside the enclosing tube 711. The fourth cathode conductor 713d is secured to the enclosing tube 711 with the second metal lead portion 722d being supported at the end of the +X-axis side of the enclosing tube 711.

The Geiger-Muller counter tube 710 includes a fourth radiation detecting unit 725d which is constituted of the fourth anode conductor 712d and the fourth cathode conductor 713d together with the inclusion of the first radiation detecting unit 125a, the second radiation detecting unit 125b, and the third radiation detecting unit 625c. The fourth radiation detecting unit 725d is the radiation detecting unit which is formed in the similar shape with the first radiation detecting unit 125a and the second radiation detecting unit 125b. The fourth radiation detecting unit 725d is different from the first radiation detecting unit 125a and the second radiation detecting unit 125b only in an arrangement position inside the enclosing tube 711. Furthermore, in the +Z-axis side of the first radiation detecting unit 125a, −Z-axis side of the second radiation detecting unit 125b, −Y-axis side of the third radiation detecting unit 625c, and −X-axis side of the fourth radiation detecting unit 725d, the beads 850 are disposed by being mounted to the anode electrodes which constitute each detecting unit.

In the radiation measurement apparatus 700, the radiation-detection sensitivity becomes higher than the radiation measurement apparatus 500 and 600 due to including four radiation detecting units. In addition, similar to the radiation measurement apparatus 600, each value of β-ray and γ-ray can be measured by covering the Geiger-Muller counter tube 710 with the shielding portion (not illustrated).

### Seventh Embodiment

In the Geiger-Muller counter tube, a through-hole may be formed in the side surface of the cathode electrode so as to make the concentration of the gas in the space inside the enclosing tube uniform. The following description describes a Geiger-Muller counter tube 60 where the through-hole is formed in the side surface of the cathode electrode. Like reference numerals designate corresponding or identical elements throughout the first embodiment, and therefore such elements will not be further elaborated here.

### [Configuration of Geiger-Muller Counter Tube 60]

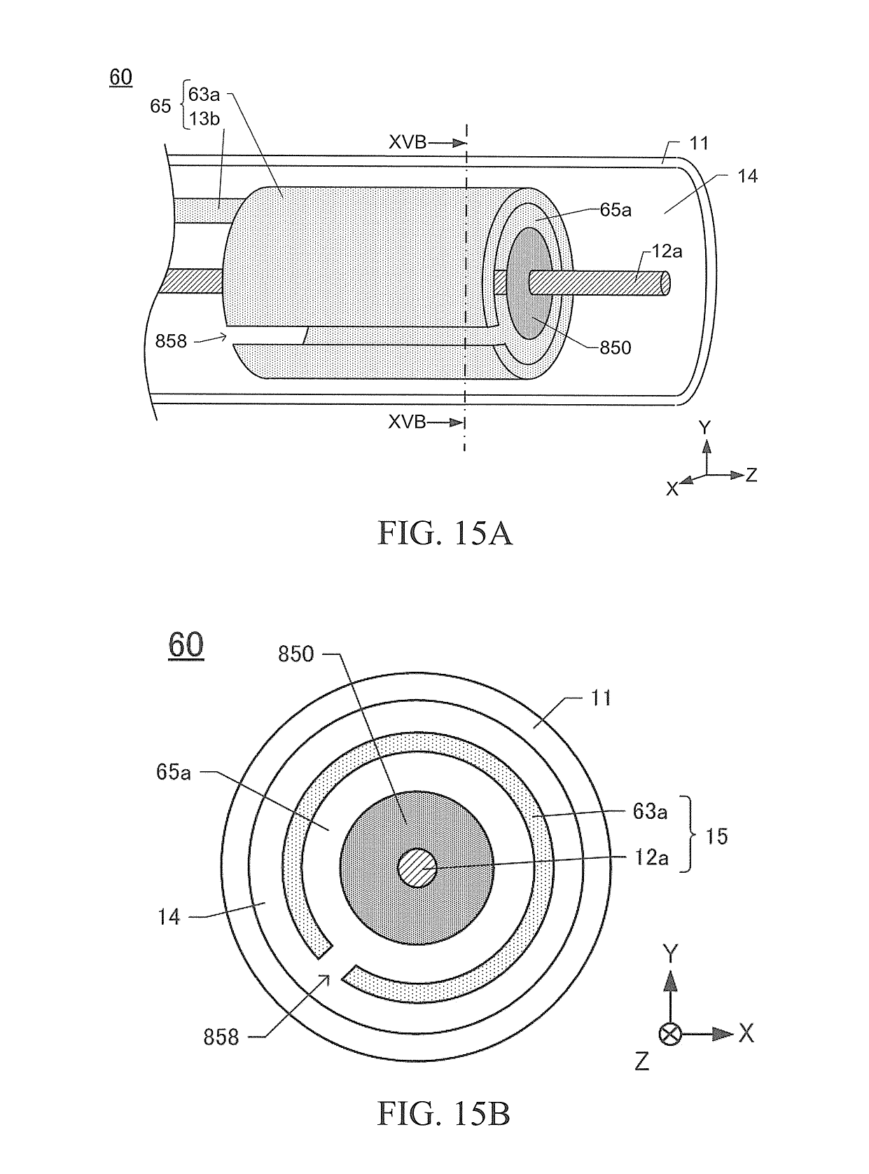

FIG. 15A is a schematic perspective view of the anode electrode 12a, the bead 850, and a cathode electrode 63a that constitute the Geiger-Muller counter tube 60. The Geiger-Muller counter tube 60 is the Geiger-Muller counter tube where, in the Geiger-Muller counter tube 10 (see FIG. 1A), the cathode electrode 63a is employed instead of the cathode electrode 13a.

The cathode electrode 63a is formed where a rectangular metal sheet is rolled into a cylindrical shape. The rectangular metal sheet is formed of, for example, metallic Kovar that is an alloy of iron, nickel, and cobalt or stainless steel. Further, the cathode electrode 63a is rolled in the shape where both end sides of the metal sheet are separated so as not to overlap the end sides one another. Thus, a slit 858 extending in the Z-axis direction is formed in the side surface of the cathode electrode 63a. The slit 858 is formed in the side surface of the cathode electrode 63a and is the through-hole which connects the inside and outside of a space 65a which is surrounded by the cathode electrode 63a.

FIG. 15B is a cross-sectional view taken along the line XVB-XVB of FIG. 15A. The anode electrode 12a is disposed on the central axis of the cathode electrode 63a. Accordingly, when a voltage is applied between the cathode electrode 63a and the anode electrode 12a, inside the XY plane, the electric field of the space 65a surrounded by the cathode electrode 63a is formed with rotational symmetry around the anode electrode 12a. In addition, in the space 14 which has the space 65a, an inert gas and a quenching gas are enclosed. The inert gas employs, for example, noble gas such as helium (He), neon (Ne), or argon (Ar). Additionally, the quenching gas employs, for example, halogen-based gas such as fluorine (F), bromine (Br) or chlorine (Cl).

In the Geiger-Muller counter tube 10, when the outside diameter W2 of the bead 850 is made larger, there is a concern that the flow of the gas inside the enclosing tube 11 becomes poor. Accordingly, there is a concern that the characteristics of the Geiger-Muller counter tube 10 are affected due to generation of the concentration difference of the gas inside the enclosing tube 11. In the cathode electrode 63a, the formation of the slit 858 improves the ventilation inside and outside of the cathode electrode 63a and prevents generation of the concentration difference of the gas inside and outside of the cathode electrode 63a.

In the cathode electrode 63a, the through-hole which connects the inside and outside of the space 65a is formed as the slit 858. However, the shape of the through-hole is not limited to the slit. The through-hole may be formed, for example, by a formation of a plurality of circular through-holes in the metal sheet. Further, by the use of a metal mesh where a plurality of metal wires are interwoven into the net instead of the metal sheet, the through-hole may be formed in the state where the mesh patterns of the metal mesh becomes the through-hole. Furthermore, these cathode electrodes may be employed not only in the first embodiment but also in other embodiments, that is, from the second embodiment to the sixth embodiment.

Additionally, for example, in the aforementioned embodiment, the cathode electrode is formed in a circular-cylindrical shape. However, the shape of the cathode electrode may be formed in other cylindrical shapes other than the circular-cylindrical shape: that is, in various shapes such as a rectangular cylindrical shape, an elliptical-cylindrical shape, a polygonal cylindrical shape.

In the Geiger-Muller counter tube according to the first aspect, the Geiger-Muller counter tube according to a second aspect may be configured as follows. The bead is formed of a hard glass, a molybdenum glass, a ceramic or plastic.

In the Geiger-Muller counter tube according to the first aspect, the Geiger-Muller counter tube according to a third aspect may be configured as follows. The bead is formed by a method where a molten glass is applied over the anode electrode and then cooled.

In the Geiger-Muller counter tube according to any one of the first to third aspects, the Geiger-Muller counter tube according to a fourth aspect may be configured as follows. The outer shape of the bead is formed in a cylindrical shape, a discoidal shape, an ellipsoidal shape, a spherical shape, or an annular ring shape.

In the Geiger-Muller counter tube according to the first or the second aspect, the Geiger-Muller counter tube according to a fifth aspect may be configured as follows. The bead has a plurality of protrusions extending toward the cathode electrode side.

In the Geiger-Muller counter tube according to any one of the first to fifth aspects, the Geiger-Muller counter tube according to a sixth aspect may be configured as follows. The bead is disposed on an opening surface of the cathode electrode where the anode electrode passes through.

A Geiger-Muller counter tube according to a seventh aspect includes a cylindrical enclosing tube, an anode electrode, a cylindrical cathode electrode, a ring, an inert gas, and a quenching gas. The cylindrical enclosing tube has a sealed space. The anode electrode is disposed inside the space and formed in a rod shape. The cylindrical cathode electrode has an opening and surrounding a peripheral area of the anode electrode inside the space. The ring is formed of an insulator and disposed in the opening. The ring has a smaller inside diameter than a diameter of the opening of the cathode electrode. The inert gas and the quenching gas are sealed inside the space. The anode electrode passes through the inside of the inside diameter of the ring. The ring prevents a direct contact between the anode electrode and the cathode electrode.

In the Geiger-Muller counter tube according to the seventh aspect, the Geiger-Muller counter tube according to an eighth aspect may be configured as follows. The ring is formed of a hard glass, a molybdenum glass, a ceramic or plastic.

In the Geiger-Muller counter tube according to the seventh or the eighth aspect, the Geiger-Muller counter tube according to a ninth aspect may be configured as follows. The ring is formed by a method where a molten glass is applied over the opening of the cathode electrode and then cooled.

A radiation measurement apparatus according to a tenth aspect includes the Geiger-Muller counter tube according to any one of the first to ninth aspects, one single high-voltage circuit unit, a counter, and a calculator. The single high-voltage circuit unit applies a predetermined high voltage between a first metal lead portion and a second metal lead portion. The counter is connected to the high-voltage circuit unit. The counter counts pulse signals measured by the Geiger-Muller counter tube. The calculator converts the pulse signals counted by the counter into a radiation dose.

The Geiger-Muller counter tube and the radiation measurement apparatus according to this disclosure ensure the suppression of the variations in the characteristics of each product and the prevention of short circuit between the electrodes.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A Geiger-Muller counter tube, comprising:
a cylindrical enclosing tube, having a space which is sealed;
an anode electrode, being disposed inside the space, and the anode electrode is formed in a rod shape;
a cathode electrode in a cylindrical shape, surrounding a peripheral area of the anode electrode inside the space;
a bead, being formed of an insulator, and a through-hole is in a center of the bead, and the anode electrode passing through the through-hole, the bead being secured to the anode electrode in a position where the anode electrode is surrounded by the cathode electrode; and
an inert gas and a quenching gas, being sealed inside the space, wherein
a direct contact between the anode electrode and the cathode electrode is prevented by using the bead.

2. The Geiger-Muller counter tube according to claim 1, wherein
the bead is formed of hard glass, molybdenum glass, ceramic or plastic.

3. The Geiger-Muller counter tube according to claim 1, wherein
the bead is formed by a method where a molten glass is applied over the anode electrode and then cooled.

4. The Geiger-Muller counter tube according to claim 1, wherein
an outer shape of the bead is formed in a cylindrical shape, a discoidal shape, an ellipsoidal shape, a spherical shape, or an annular ring shape.

5. The Geiger-Muller counter tube according to claim 1, wherein
the bead has a plurality of protrusions which are extended toward a side of the cathode electrode.

6. The Geiger-Muller counter tube according to claim 1, wherein
the bead is disposed on an opening surface of the cathode electrode where the anode electrode passes through.

7. A Geiger-Muller counter tube, comprising:
a cylindrical enclosing tube, having a space which is sealed;
an anode electrode, being disposed inside the space, and the anode electrode is formed in a rod shape;
a cathode electrode in a cylindrical shape, having an opening and surrounding a peripheral area of the anode electrode inside the space;
a ring, being formed of an insulator and disposed in the opening, and the ring having a inside diameter smaller than a diameter of the opening of the cathode electrode; and
an inert gas and a quenching gas, being sealed inside the space, wherein
the anode electrode passing through the inside of the inside diameter of the ring, and a direct contact between the anode electrode and the cathode electrode is prevented by using the ring.

8. The Geiger-Muller counter tube according to claim 7, wherein
the ring is foamed of hard glass, molybdenum glass, ceramic or plastic.

9. The Geiger-Muller counter tube according to claim 7, wherein
the ring is formed by a method where a molten glass is applied over the opening of the cathode electrode and then cooled.

10. A radiation measurement apparatus, comprising:
the Geiger-Muller counter tube according to claim 1;
a first metal lead portion;
a second metal lead portion;
one single high-voltage circuit unit, applying a predetermined high voltage between the first metal lead portion and the second metal lead portion;
a counter, being connected to the high-voltage circuit unit, and the counter counts pulse signals measured by the Geiger-Muller counter tube; and
a calculator, converting the pulse signals counted by the counter into a radiation dose.

11. A radiation measurement apparatus, comprising:
the Geiger-Muller counter tube according to claim 7;
a first metal lead portion;
a second metal lead portion;
one single high-voltage circuit unit, applying a predetermined high voltage between the first metal lead portion and the second metal lead portion;
a counter, being connected to the high-voltage circuit unit, and the counter counts pulse signals measured by the Geiger-Muller counter tube; and
a calculator, converting the pulse signals counted by the counter into a radiation dose.
